(19) United States
(12) Patent Application Publication
(10) Pub. No.: US 2022/0397647 A1
(43) Pub. Date: Dec. 15, 2022

(54) MULTIBEAM SPINNING LIDAR SYSTEM

(71) Applicant: Innoviz Technologies Ltd., Rosh Ha'Ayin (IL)

(72) Inventors: Nir GOREN, Herut (IL); Uri POMERANTZ, Tel-Aviv (IL); Yonatan KORNER, Modi'in-Maccabim-Re'ut (IL); Nimrod ARI, Kokhav-Yair (IL)

(73) Assignee: Innoviz Technologies Ltd., Rosh Ha'Ayin (IL)

(21) Appl. No.: 17/837,356

(22) Filed: Jun. 10, 2022

Related U.S. Application Data
(60) Provisional application No. 63/208,979, filed on Jun. 10, 2021.

(51) Int. Cl. G01S 7/481; G01S 17/931; G01S 17/42; G01S 17/894; G02B 26/10; G01S 17/10

(52) U.S. Cl. CPC G01S 7/4817; G01S 17/931; G01S 17/42; G01S 17/894; G01S 7/4814; G02B 26/105; G01S 7/4812; G01S 17/10

(57) ABSTRACT

A LIDAR system includes a light source configured to generate a plurality of laser beams arranged in a beam pattern, a rotatable deflector configured to rotate about a scanning axis, a beam rotator configured to cause rotation of the beam pattern of the plurality of laser beams relative to the scanning axis of the rotatable deflector and at least one sensor configured to receive, via the rotatable deflector and the beam rotator, laser light resulting from one or more of the plurality of laser beams reflected from at least one object in the field of view of the LIDAR system wherein the multibeam array is maintained at a substantially fixed orientation with respect to the optical axis.

### CROSS REFERENCE TO RELATED APPLICATION

The present application claims priority to U.S. Provisional Patent Application No. 63/208,979 filed Jun. 10, 2021, which is incorporated herein by reference in its entirety.

### TECHNICAL FIELD

The present disclosure relates generally to technology for scanning a surrounding environment and, for example, to systems and methods that use LIDAR technology to detect objects in the surrounding environment.

### BACKGROUND

With the advent of driver assist systems and autonomous vehicles, automobiles need to be equipped with systems capable of reliably sensing and interpreting their surroundings, including identifying obstacles, hazards, objects, and other physical parameters that might impact navigation of the vehicle. To this end, a number of differing technologies have been suggested including radar, LIDAR, camera-based systems, operating alone or in a redundant manner.

One consideration with driver assistance systems and autonomous vehicles is an ability of the system to determine surroundings across different conditions. A light detection and ranging system, (LIDAR a/k/a LADAR) is an example of technology that operates by illuminating objects with light and measuring the reflected pulses with a sensor. Based on measure times of flight at different spatial locations, in a field of view (FOV), such as FOV pixels, a point cloud of range data may be generated where each FOV pixel is associated with a particular range measurement value corresponding to a distance between the LIDAR system and objects or portions of objects in the LIDAR FOV. A laser is one example of a light source that can be used in a LIDAR system. An electro-optical system such as a LIDAR system may include a light deflector for projecting light emitted by a light source into the environment of the electro-optical system. The light deflector may be controlled to pivot around at least one axis for projecting the light into a desired location in the field of view of the electro-optical system.

In some cases, the light deflector may rotate or spin about a vertically oriented scanning axis to project light from a laser light source to a 360-degree FOV about the LIDAR system. The use of a spinning deflector, however, can present challenges in accurately projecting laser light along horizontal scan lines relative to the FOV. Such challenges are significant, especially in cases in which the laser light source includes more than one beam and where the laser light source is not rotated together with the deflector.

The systems and methods of the present disclosure are directed towards the use of multibeam laser light sources with spinning light deflectors to provide 360 degree scans of a LIDAR FOV.

### SUMMARY

A LIDAR system includes a light source configured to generate a plurality of laser beams arranged in a beam pattern, a rotatable deflector configured to rotate about a scanning axis, a beam rotator configured to cause rotation of the beam pattern of the plurality of laser beams relative to the scanning axis of the rotatable deflector and at least one sensor configured to receive, via the rotatable deflector and the beam rotator, laser light resulting from one or more of the plurality of laser beams reflected from at least one object in the field of view of the LIDAR system wherein the multibeam array is maintained at a substantially fixed orientation with respect to the optical axis.

In some embodiments, a LIDAR system may include a light source configured to generate at least one laser beam having an elongated cross section. The system may also include a rotatable deflector configured to rotate about a scanning axis and to deflect the at least one laser beam toward a field of view of the LIDAR system; a beam rotator configured to cause rotation of the elongated cross section of the at least one laser beam relative to the scanning axis of the rotatable deflector; and at least one sensor configured to receive, via the rotatable deflector and the beam rotator, laser light resulting from the at least one laser beam reflected from at least one object in the field of view of the LIDAR system.

### BRIEF DESCRIPTION OF DRAWING(S)

FIG. 1A is a diagram illustrating an exemplary LIDAR system consistent with disclosed embodiments.

FIG. 1B is an image showing an exemplary output of single scanning cycle of a LIDAR system mounted on a vehicle consistent with disclosed embodiments.

FIG. 1C is another image showing a representation of a point cloud model determined from output of a LIDAR system consistent with disclosed embodiments.

FIGS. 2A and 2B are diagrams illustrating different configurations of projecting units in accordance with some embodiments of the present disclosure.

FIG. 3 provides a diagrammatic illustration of a scanning unit configuration in accordance with some embodiments of the present disclosure.

FIGS. 4A, 4B, and 4C are diagrams illustrating different configurations of sensing units in accordance with some embodiments of the present disclosure.

FIG. 5A includes four example diagrams illustrating emission patterns in a single frame-time for a single portion of the field of view.

FIG. 5B includes three example diagrams illustrating emission scheme in a single frame-time for the whole field of view.

FIG. 6 is a diagram illustrating the actual light emission projected towards and reflections received during a single frame-time for the whole field of view.

FIG. 7A-7D are diagrammatic representations of a conceptual LIDAR system including a rotatable deflector combined with a multibeam light source.

FIG. 8A provides a diagrammatic representation of a LIDAR system, consistent with exemplary disclosed embodiments.

FIG. 8B provides a diagrammatic representation of an arrangement for incrementing scan lines relative to a LIDAR FOV, consistent with exemplary disclosed embodiments.

FIGS. 8C and 8D represent a technique for providing variable scan resolution, consistent with exemplary disclosed embodiments.

FIGS. 8E-8H represent the rotation of a beam pattern relative to a scanning deflector, consistent with exemplary disclosed embodiments.

FIGS. 8I-8K represent another technique for selectively controlling scan resolution, consistent with exemplary disclosed embodiments.

FIG. 9 is a diagram illustrating a system in accordance with some embodiments of the invention.

FIGS. 10A-10C are diagrammatic representations of optical paths consistent with the example system of FIG. 8A.

FIG. 10D provides examples of the optics layout of an exemplary LIDAR system, consistent with exemplary disclosed embodiments.

FIGS. 11A-11B provide diagrammatic representations of a Dove prism that may be used in some embodiments of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Disclosed embodiments may involve an optical system. As used herein, the term “optical system” broadly includes any system that is used for the generation, detection and/or manipulation of light. By way of example only, an optical system may include one or more optical components for generating, detecting and/or manipulating light. For example, light sources, lenses, mirrors, prisms, beam splitters, collimators, polarizing optics, optical modulators, optical switches, optical amplifiers, optical detectors, optical sensors, fiber optics, semiconductor optic components, while each not necessarily required, may each be part of an optical system. In addition to the one or more optical components, an optical system may also include other non-optical components such as electrical components, mechanical components, chemical reaction components, and semiconductor components. The non-optical components may cooperate with optical components of the optical system. For example, the optical system may include at least one processor for analyzing detected light.

Consistent with the present disclosure, the optical system may be a LIDAR system. As used herein, the term “LIDAR system” broadly includes any system which can determine values of parameters indicative of a distance between a pair of tangible objects based on reflected light. In one embodiment, the LIDAR system may determine a distance between a pair of tangible objects based on reflections of light emitted by the LIDAR system. As used herein, the term “determine distances” broadly includes generating outputs which are indicative of distances between pairs of tangible objects. The determined distance may represent the physical dimension between a pair of tangible objects. By way of example only, the determined distance may include a line of flight distance between the LIDAR system and another tangible object in a field of view of the LIDAR system. In another embodiment, the LIDAR system may determine the relative velocity between a pair of tangible objects based on reflections of light emitted by the LIDAR system. Examples of outputs indicative of the distance between a pair of tangible objects include: a number of standard length units between the tangible objects (e.g., number of meters, number of inches, number of kilometers, number of millimeters), a number of arbitrary length units (e.g., number of LIDAR system lengths), a ratio between the distance to another length (e.g., a ratio to a length of an object detected in a field of view of the LIDAR system), an amount of time (e.g., given as standard unit, arbitrary units or ratio, for example, the time it takes light to travel between the tangible objects), one or more locations (e.g., specified using an agreed coordinate system, specified in relation to a known location), and more.

The LIDAR system may determine the distance between a pair of tangible objects (e.g., the LIDAR system and one or more objects in the LIDAR FOV) based on reflected light. In one embodiment, the LIDAR system may process detection results of a sensor which creates temporal information indicative of a period of time between the emission of a light signal and the time of its detection by the sensor. The period of time is occasionally referred to as “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal traveled between emission and detection. In another embodiment, the LIDAR system may determine the distance based on frequency phase-shift (or multiple frequency phase-shift). Specifically, the LIDAR system may process information indicative of one or more modulation phase shifts (e.g., by solving some simultaneous equations to give a final measure) of the light signal. For example, the emitted optical signal may be modulated with one or more constant frequencies. The at least one phase shift of the modulation between the emitted signal and the detected reflection may be indicative of the distance the light traveled between emission and detection. The modulation may be applied to a continuous wave light signal, to a quasi-continuous wave light signal, or to another type of emitted light signal. It is noted that additional information may be used by the LIDAR system for determining the distance, e.g., location information (e.g., relative positions) between the projection location, the detection location of the signal (especially if distanced from one another), and more.

In some embodiments, the LIDAR system may be used for detecting a plurality of objects in an environment of the LIDAR system. The term “detecting an object in an environment of the LIDAR system” broadly includes generating information which is indicative of an object that reflected light toward a detector associated with the LIDAR system. If more than one object is detected by the LIDAR system, the generated information pertaining to different objects may be interconnected, for example a car is driving on a road, a bird is sitting on the tree, a man touches a bicycle, a van moves towards a building. The dimensions of the environment in which the LIDAR system detects objects may vary with respect to implementation. For example, the LIDAR system may be used for detecting a plurality of objects in an environment of a vehicle on which the LIDAR system is installed, up to a horizontal distance of 100 m (or 200 m, 300 m, etc.), and up to a vertical distance of 10 m (or 25 m, 50 m, etc.). In another example, the LIDAR system may be used for detecting a plurality of objects in an environment of a vehicle or within a predefined horizontal range (e.g., 25°, 50°, 100°, 180°, etc.), and up to a predefined vertical elevation (e.g., ±10°, ±20°, +40°-20°, ±90° or) 0°-90°.

As used herein, the term “detecting an object” may broadly refer to determining an existence of the object (e.g., an object may exist in a certain direction with respect to the LIDAR system and/or to another reference location, or an object may exist in a certain spatial volume). Additionally or alternatively, the term “detecting an object” may refer to determining a distance between the object and another location (e.g., a location of the LIDAR system, a location on earth, or a location of another object). Additionally or alternatively, the term “detecting an object” may refer to identifying the object (e.g., classifying a type of object such as car, plant, tree, road; recognizing a specific object (e.g., the Washington Monument); determining a license plate number; determining a composition of an object (e.g., solid, liquid, transparent, semitransparent); determining a kinematic parameter of an object (e.g., whether it is moving, its velocity, its movement direction, expansion of the object). Additionally or alternatively, the term “detecting an object” may refer to generating a point cloud map in which every point of one or more points of the point cloud map correspond to a location in the object or a location on a face thereof. In one embodiment, the data resolution associated with the point cloud map representation of the field of view may be associated with 0.1°×0.1° or 0.3°×0.3° of the field of view.

Consistent with the present disclosure, the term “object” broadly includes a finite composition of matter that may reflect light from at least a portion thereof. For example, an object may be at least partially solid (e.g., cars, trees); at least partially liquid (e.g., puddles on the road, rain); at least partly gaseous (e.g., fumes, clouds); made from a multitude of distinct particles (e.g., sand storm, fog, spray); and may be of one or more scales of magnitude, such as ˜1 millimeter (mm), ˜5 mm, ˜10 mm, ˜50 mm, ˜100 mm, ˜500 mm, ˜1 meter (m), ˜5 m, ˜10 m, ˜50 m, ˜100 m, and so on. Smaller or larger objects, as well as any size in between those examples, may also be detected. It is noted that for various reasons, the LIDAR system may detect only part of the object. For example, in some cases, light may be reflected from only some sides of the object (e.g., only the side opposing the LIDAR system will be detected); in other cases, light may be projected on only part of the object (e.g., laser beam projected onto a road or a building); in other cases, the object may be partly blocked by another object between the LIDAR system and the detected object; in other cases, the LIDAR's sensor may only detects light reflected from a portion of the object, e.g., because ambient light or other interferences interfere with detection of some portions of the object.

Consistent with the present disclosure, a LIDAR system may be configured to detect objects by scanning the environment of LIDAR system. The term “scanning the environment of LIDAR system” broadly includes illuminating the field of view or a portion of the field of view of the LIDAR system. In one example, scanning the environment of LIDAR system may be achieved by moving or pivoting a light deflector to deflect light in differing directions toward different parts of the field of view. In another example, scanning the environment of LIDAR system may be achieved by changing a positioning (i.e. location and/or orientation) of a sensor with respect to the field of view. In another example, scanning the environment of LIDAR system may be achieved by changing a positioning (i.e. location and/or orientation) of a light source with respect to the field of view. In yet another example, scanning the environment of LIDAR system may be achieved by changing the positions of at least one light source and of at least one sensor to move rigidly with respect to the field of view (i.e. the relative distance and orientation of the at least one sensor and of the at least one light source remains).

As used herein the term “field of view of the LIDAR system” may broadly include an extent of the observable environment of LIDAR system in which objects may be detected. It is noted that the field of view (FOV) of the LIDAR system may be affected by various conditions such as but not limited to: an orientation of the LIDAR system (e.g., is the direction of an optical axis of the LIDAR system); a position of the LIDAR system with respect to the environment (e.g., distance above ground and adjacent topography and obstacles); operational parameters of the LIDAR system (e.g., emission power, computational settings, defined angles of operation), etc. The field of view of LIDAR system may be defined, for example, by a solid angle (e.g., defined using ϕ, θ angles, in which ϕ and θ are angles defined in perpendicular planes, e.g., with respect to symmetry axes of the LIDAR system and/or its FOV). In one example, the field of view may also be defined within a certain range (e.g., up to 200 m).

Similarly, the term “instantaneous field of view” may broadly include an extent of the observable environment in which objects may be detected by the LIDAR system at any given moment. For example, for a scanning LIDAR system, the instantaneous field of view is narrower than the entire FOV of the LIDAR system, and it can be moved within the FOV of the LIDAR system in order to enable detection in other parts of the FOV of the LIDAR system. The movement of the instantaneous field of view within the FOV of the LIDAR system may be achieved by moving a light deflector of the LIDAR system (or external to the LIDAR system), so as to deflect beams of light to and/or from the LIDAR system in differing directions. In one embodiment, LIDAR system may be configured to scan a scene in the environment in which the LIDAR system is operating. As used herein the term “scene” may broadly include some or all of the objects within the field of view of the LIDAR system, in their relative positions and in their current states, within an operational duration of the LIDAR system. For example, the scene may include ground elements (e.g., earth, roads, grass, sidewalks, road surface marking), sky, man-made objects (e.g., vehicles, buildings, signs), vegetation, people, animals, light projecting elements (e.g., flashlights, sun, other LIDAR systems), and so on.

Disclosed embodiments may involve obtaining information for use in generating reconstructed three-dimensional models. Examples of types of reconstructed three-dimensional models which may be used include point cloud models, and Polygon Mesh (e.g., a triangle mesh). The terms “point cloud” and “point cloud model” are widely known in the art, and should be construed to include a set of data points located spatially in some coordinate system (i.e., having an identifiable location in a space described by a respective coordinate system). The term “point cloud point” refer to a point in space (which may be dimensionless, or a miniature cellular space, e.g., 1 cm3), and whose location may be described by the point cloud model using a set of coordinates (e.g., (X,Y,Z), (r,ϕ,θ)). By way of example only, the point cloud model may store additional information for some or all of its points (e.g., color information for points generated from camera images). Likewise, any other type of reconstructed three-dimensional model may store additional information for some or all of its objects. Similarly, the terms “polygon mesh” and “triangle mesh” are widely known in the art, and are to be construed to include, among other things, a set of vertices, edges and faces that define the shape of one or more 3D objects (such as a polyhedral object). The faces may include one or more of the following: triangles (triangle mesh), quadrilaterals, or other simple convex polygons, since this may simplify rendering. The faces may also include more general concave polygons, or polygons with holes. Polygon meshes may be represented using differing techniques, such as: Vertex-vertex meshes, Face-vertex meshes, Winged-edge meshes and Render dynamic meshes. Different portions of the polygon mesh (e.g., vertex, face, edge) are located spatially in some coordinate system (i.e., having an identifiable location in a space described by the respective coordinate system), either directly and/or relative to one another. The generation of the reconstructed three-dimensional model may be implemented using any standard, dedicated and/or novel photogrammetry technique, many of which are known in the art. It is noted that other types of models of the environment may be generated by the LIDAR system.

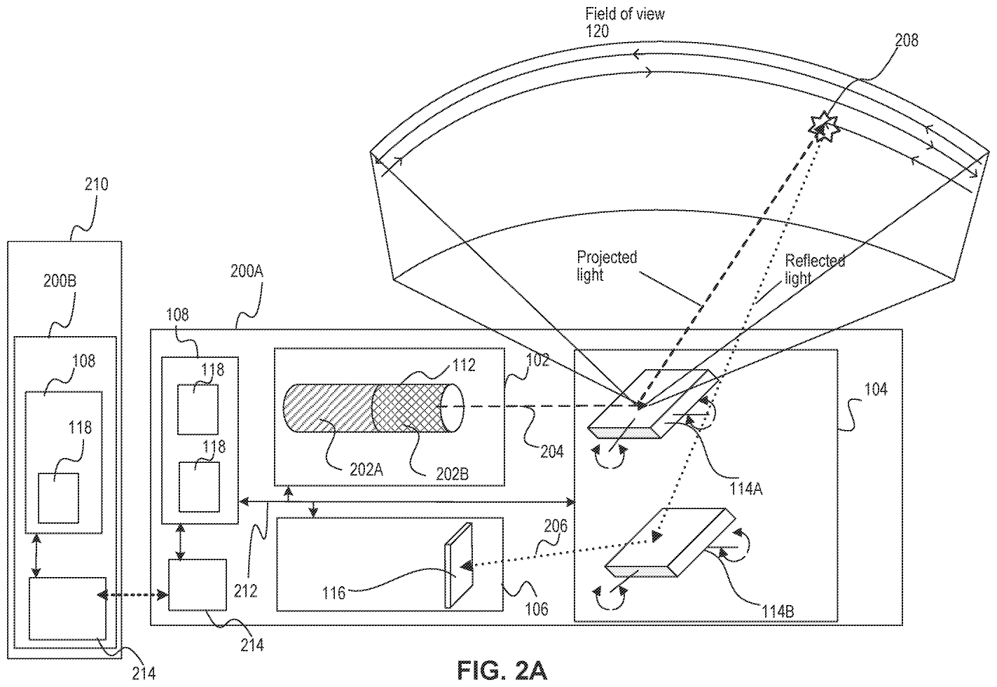

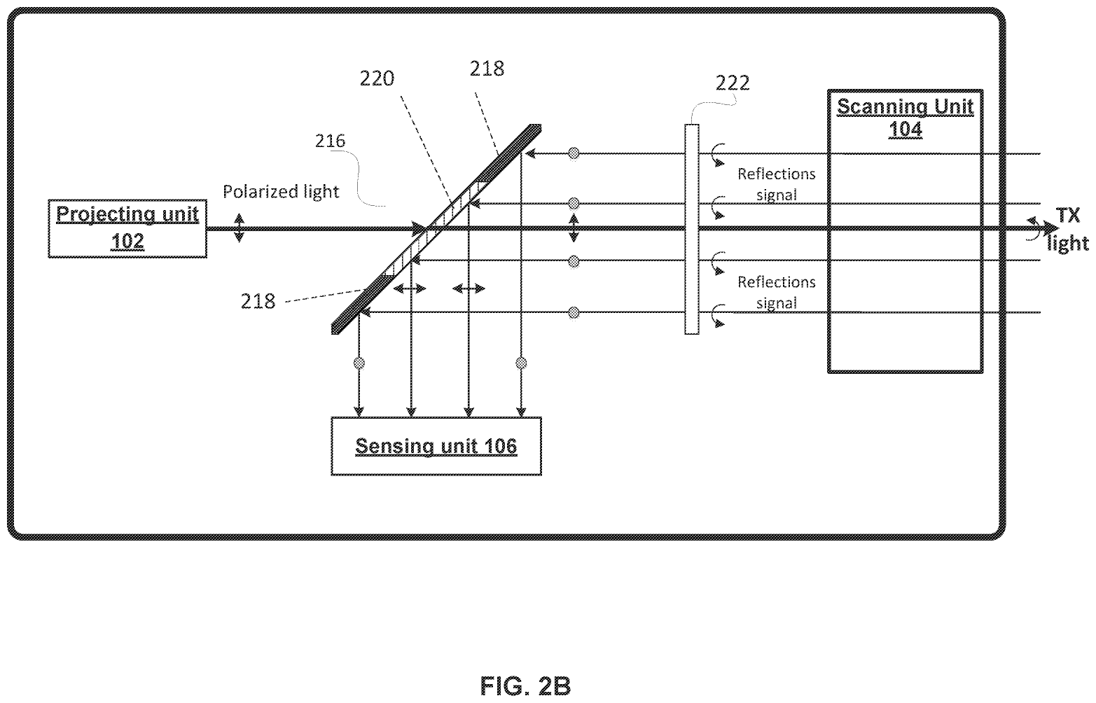

Consistent with disclosed embodiments, the LIDAR system may include at least one projecting unit with a light source configured to project light. As used herein the term “light source” broadly refers to any device configured to emit light. In one embodiment, the light source may be a laser such as a solid-state laser, laser diode, a high power laser, or an alternative light source such as, a light emitting diode (LED)-based light source. In addition, light source 112 as illustrated throughout the figures, may emit light in differing formats, such as light pulses, continuous wave (CW), quasi-CW, and so on. For example, one type of light source that may be used is a vertical-cavity surface-emitting laser (VCSEL). Another type of light source that may be used is an external cavity diode laser (ECDL). In some examples, the light source may include a laser diode configured to emit light at a wavelength between about 650 nm and 1150 nm. Alternatively, the light source may include a laser diode configured to emit light at a wavelength between about 800 nm and about 1000 nm, between about 850 nm and about 950 nm, or between about 1300 nm and about 1600 nm. Unless indicated otherwise, the term “about” with regards to a numeric value is defined as a variance of up to 5% with respect to the stated value. Additional details on the projecting unit and the at least one light source are described below with reference to FIGS. 2A-2C.

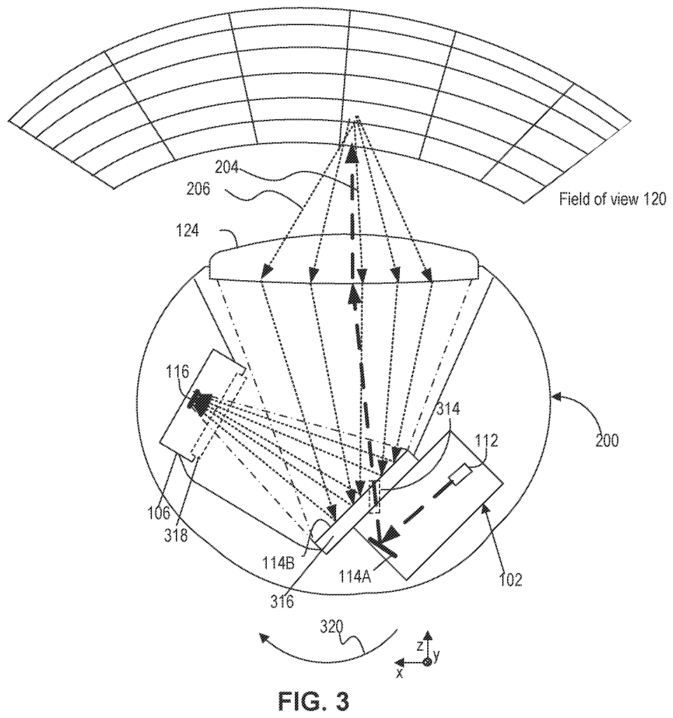

Consistent with disclosed embodiments, the LIDAR system may include at least one scanning unit with at least one light deflector configured to deflect light from the light source in order to scan the field of view. The term “light deflector” broadly includes any mechanism or module which is configured to make light deviate from its original path; for example, a mirror, a prism, controllable lens, a mechanical mirror, mechanical scanning polygons, active diffraction (e.g., controllable LCD), Risley prisms, non-mechanical-electro-optical beam steering (such as made by Vscent), polarization grating (such as offered by Boulder Non-Linear Systems), optical phased array (OPA), and more. In one embodiment, a light deflector may include a plurality of optical components, such as at least one reflecting element (e.g., a mirror), at least one refracting element (e.g., a prism, a lens), and so on. In one example, the light deflector may be movable, to cause light deviate to differing degrees (e.g., discrete degrees, or over a continuous span of degrees). The light deflector may optionally be controllable in different ways (e.g., deflect to a degree a, change deflection angle by Δα, move a component of the light deflector by M millimeters, change speed in which the deflection angle changes). In addition, the light deflector may optionally be operable to change an angle of deflection within a single plane (e.g., θ coordinate). The light deflector may optionally be operable to change an angle of deflection within two non-parallel planes (e.g., θ and ϕ coordinates). Alternatively or in addition, the light deflector may optionally be operable to change an angle of deflection between predetermined settings (e.g., along a predefined scanning route) or otherwise. With respect the use of light deflectors in LIDAR systems, it is noted that a light deflector may be used in the outbound direction (also referred to as transmission direction, or TX) to deflect light from the light source to at least a part of the field of view. However, a light deflector may also be used in the inbound direction (also referred to as reception direction, or RX) to deflect light from at least a part of the field of view to one or more light sensors. Additional details on the scanning unit and the at least one light deflector are described below with reference to FIGS. 3A-3C.

Disclosed embodiments may involve pivoting the light deflector in order to scan the field of view. As used herein the term “pivoting” broadly includes rotating of an object (especially a solid object) about one or more axis of rotation, while substantially maintaining a center of rotation fixed. In one embodiment, the pivoting of the light deflector may include rotation of the light deflector about a fixed axis (e.g., a shaft), but this is not necessarily so. In some cases, the fixed axis may be a substantially vertically oriented scanning axis, and pivoting of the deflector includes rotation of the deflector about the vertical scanning axis to project laser light to the LIDAR FOV, e.g., along one or more horizontally oriented scan lines. In some cases, the light deflector may be spun or rotated a full 360 degrees such that the horizontal scan lines extend over and establish a full 360 degree LIDAR FOV.

Disclosed embodiments may involve receiving reflections associated with a portion of the field of view corresponding to a single instantaneous position of the light deflector. As used herein, the term “instantaneous position of the light deflector” (also referred to as “state of the light deflector”) broadly refers to the location or position in space where at least one controlled component of the light deflector is situated at an instantaneous point in time, or over a short span of time. In one embodiment, the instantaneous position of light deflector may be gauged with respect to a frame of reference. The frame of reference may pertain to at least one fixed point in the LIDAR system. Or, for example, the frame of reference may pertain to at least one fixed point in the scene. In some embodiments, the instantaneous position of the light deflector may include some movement of one or more components of the light deflector (e.g., mirror, prism), usually to a limited degree with respect to the maximal degree of change during a scanning of the field of view. For example, a scanning of the entire the field of view of the LIDAR system may include changing deflection of light over a span of 30°, and the instantaneous position of the at least one light deflector may include angular shifts of the light deflector within 0.05°. In other embodiments, the term “instantaneous position of the light deflector” may refer to the positions of the light deflector during acquisition of light which is processed to provide data for a single point of a point cloud (or another type of 3D model) generated by the LIDAR system. In some embodiments, an instantaneous position of the light deflector may correspond with a fixed position or orientation in which the deflector pauses for a short time during illumination of a particular sub-region of the LIDAR field of view. In other cases, an instantaneous position of the light deflector may correspond with a certain position/orientation along a scanned range of positions/orientations of the light deflector that the light deflector passes through as part of a continuous or semi-continuous scan of the LIDAR field of view. In some embodiments, the light deflector may be moved such that during a scanning cycle of the LIDAR FOV the light deflector is located at a plurality of different instantaneous positions. In other words, during the period of time in which a scanning cycle occurs, the deflector may be moved through a series of different instantaneous positions/orientations, and the deflector may reach each different instantaneous position/orientation at a different time during the scanning cycle.

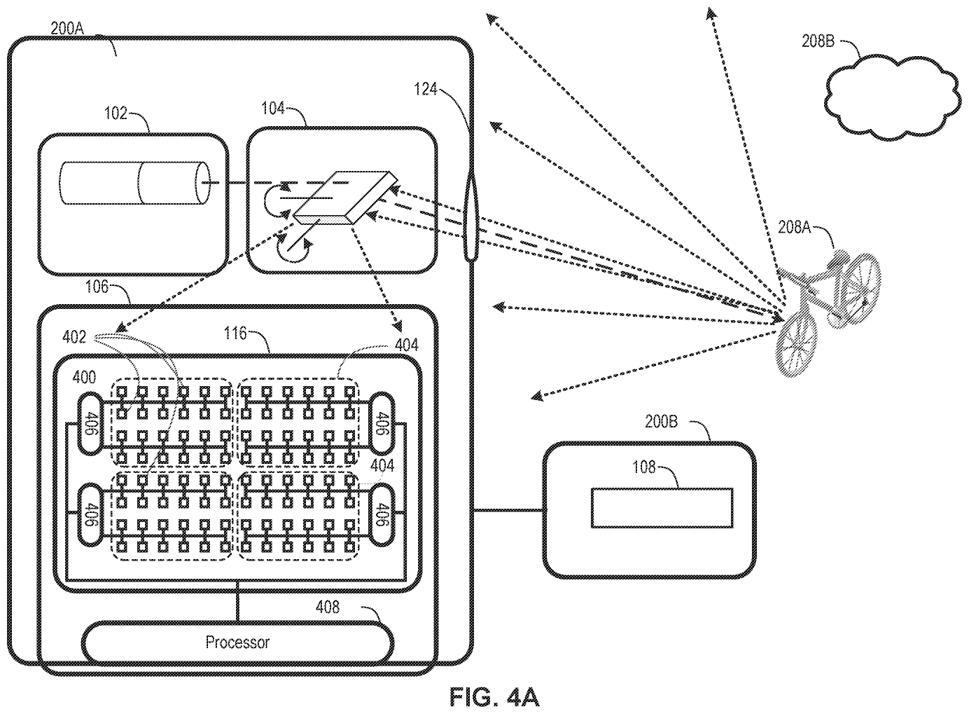

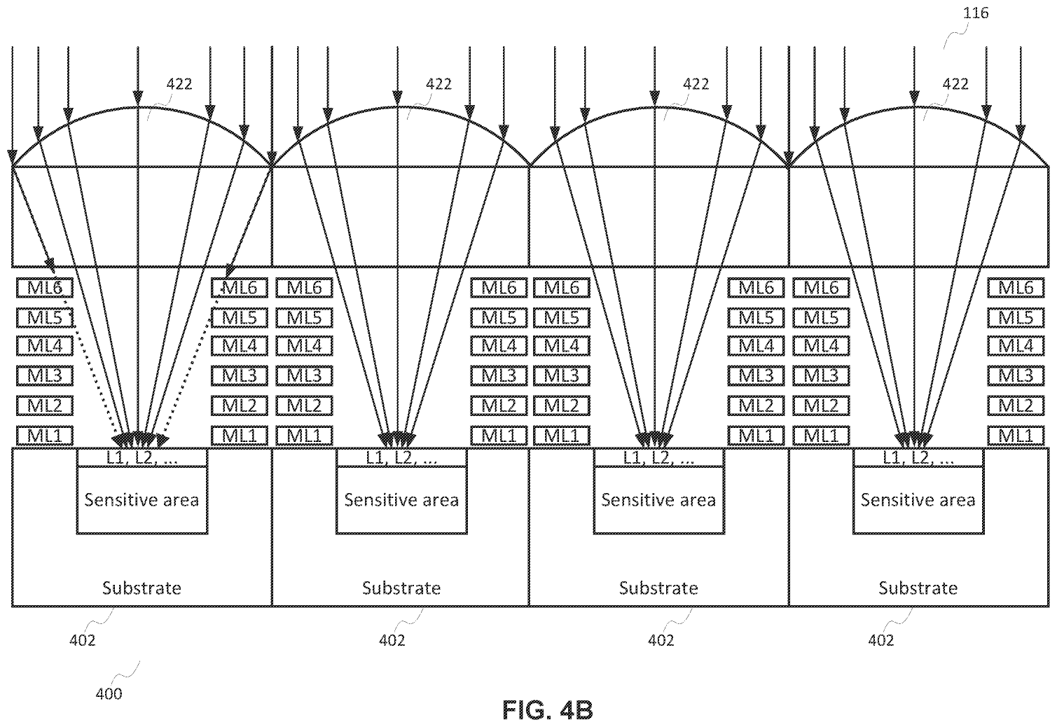

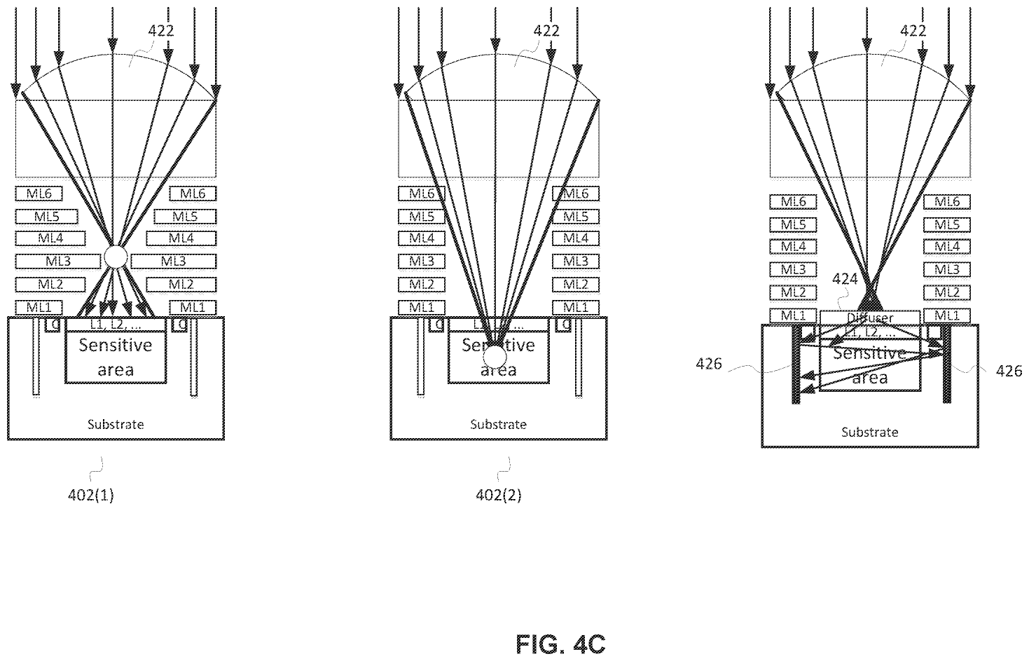

Consistent with disclosed embodiments, the LIDAR system may include at least one sensing unit with at least one sensor configured to detect reflections from objects in the field of view. The term “sensor” broadly includes any device, element, or system capable of measuring properties (e.g., power, frequency, phase, pulse timing, pulse duration) of electromagnetic waves and to generate an output relating to the measured properties. In some embodiments, the at least one sensor may include a plurality of detectors constructed from a plurality of detecting elements. The at least one sensor may include light sensors of one or more types. It is noted that the at least one sensor may include multiple sensors of the same type which may differ in other characteristics (e.g., sensitivity, size). Other types of sensors may also be used. Combinations of several types of sensors can be used for different reasons, such as improving detection over a span of ranges (especially in close range); improving the dynamic range of the sensor; improving the temporal response of the sensor; and improving detection in varying environmental conditions (e.g., atmospheric temperature, rain, etc.). In one embodiment, the at least one sensor includes a SiPM (Silicon photomultipliers) which is a solid-state single-photon-sensitive device built from an array of avalanche photodiode (APD), single photon avalanche diode (SPAD), serving as detection elements on a common silicon substrate. In one example, a typical distance between SPADs may be between about 10 μm and about 50 μm, wherein each SPAD may have a recovery time of between about 20 ns and about 100 ns. Similar photomultipliers from other, non-silicon materials may also be used. Although a SiPM device works in digital/switching mode, the SiPM is an analog device because all the microcells may be read in parallel, making it possible to generate signals within a dynamic range from a single photon to hundreds and thousands of photons detected by the different SPADs. It is noted that outputs from different types of sensors (e.g., SPAD, APD, SiPM, PIN diode, Photodetector) may be combined together to a single output which may be processed by a processor of the LIDAR system. Additional details on the sensing unit and the at least one sensor are described below with reference to FIGS. 4A-4C.

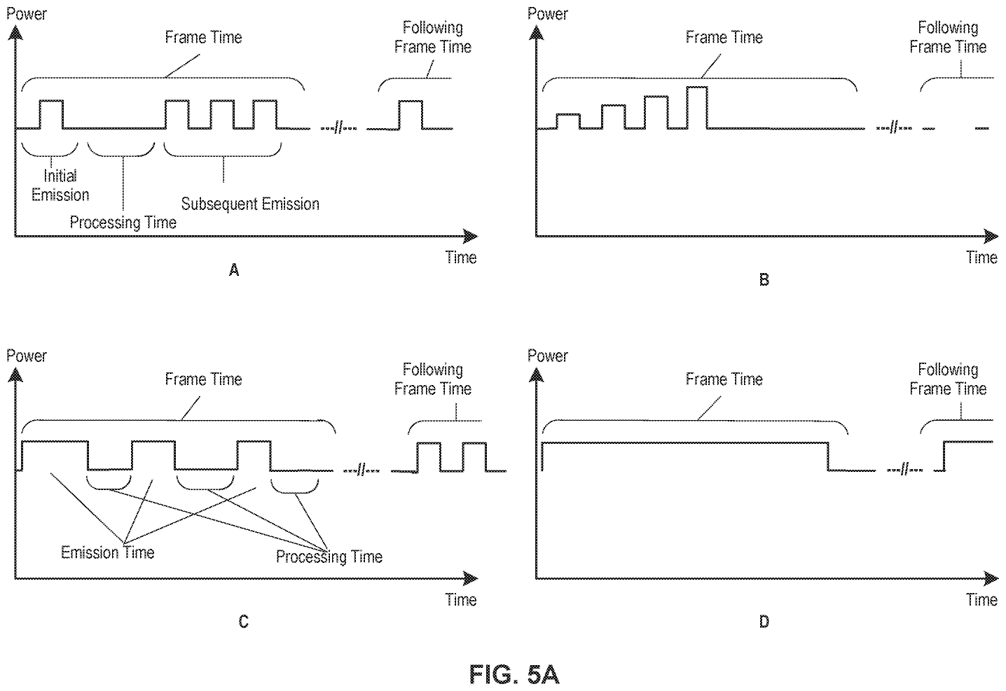

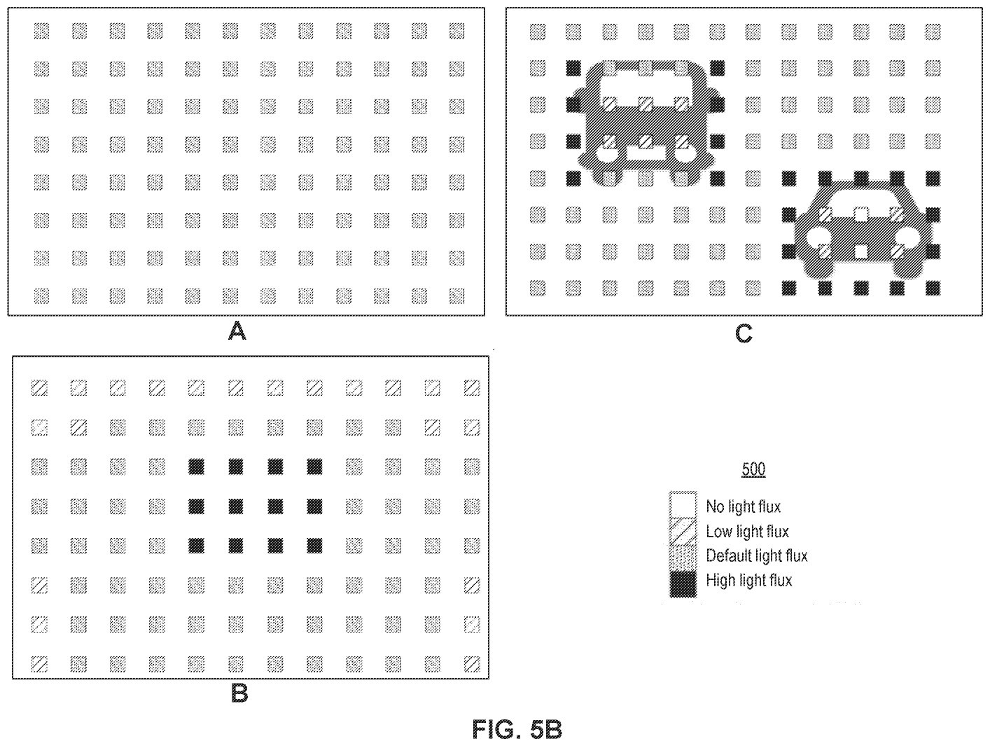

Consistent with disclosed embodiments, the LIDAR system may include or communicate with at least one processor configured to execute differing functions. The at least one processor may constitute any physical device having an electric circuit that performs a logic operation on input or inputs. For example, the at least one processor may include one or more integrated circuits (IC), including Application-specific integrated circuit (ASIC), microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. The instructions executed by at least one processor may, for example, be pre-loaded into a memory integrated with or embedded into the controller or may be stored in a separate memory. The memory may comprise a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the memory is configured to store information representative data about objects in the environment of the LIDAR system. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact. Additional details on the processing unit and the at least one processor are described below with reference to FIGS. 5A-5C.

System Overview

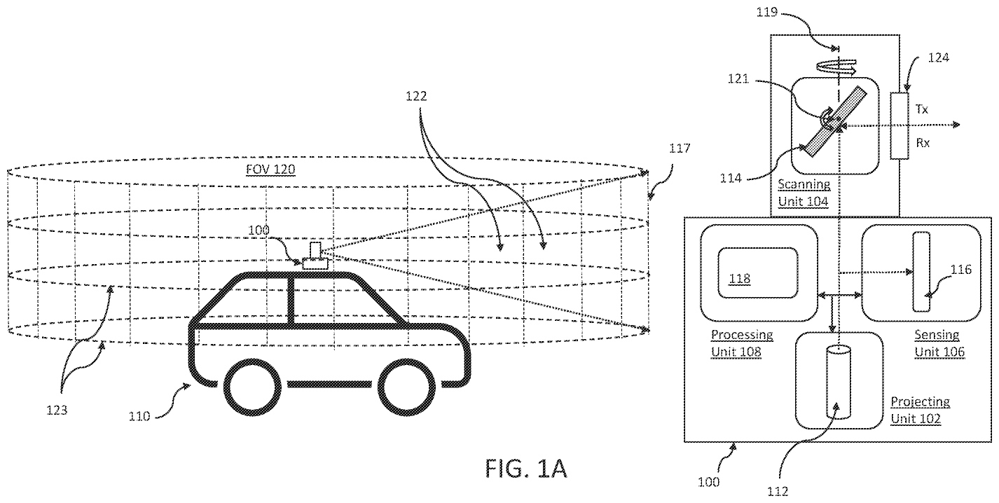

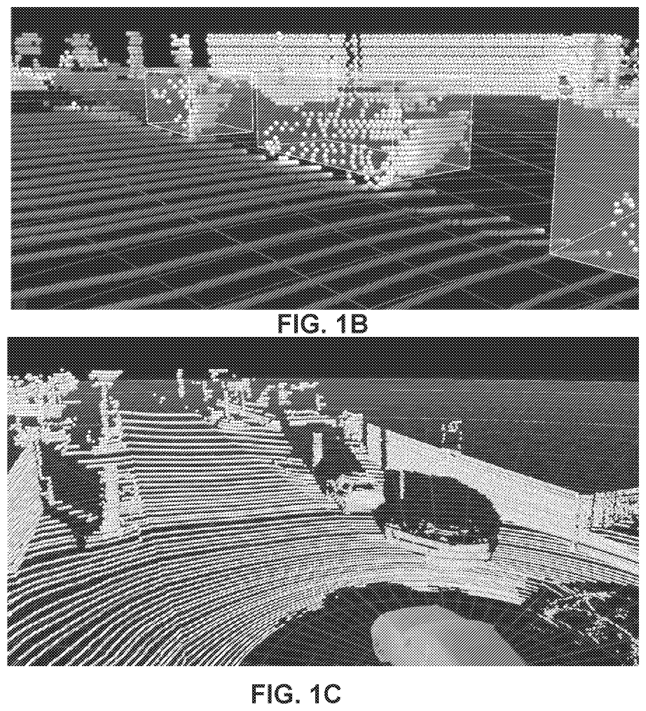

FIG. 1A illustrates a LIDAR system 100 including a projecting unit 102, a scanning unit 104, a sensing unit 106, and a processing unit 108. LIDAR system 100 may be mountable on a vehicle 110. Consistent with embodiments of the present disclosure, projecting unit 102 may include at least one light source 112, scanning unit 104 may include at least one light deflector 114, sensing unit 106 may include at least one sensor 116, and processing unit 108 may include at least one processor 118. In one embodiment processor 118 may be configured (programmed) to coordinate operation of light source 112 with the movement of deflector 114 in order to scan a field of view 120. During a scanning cycle, each instantaneous position of at least one light deflector 114 may be associated with a particular portion 122 of field of view (FOV) 120. In addition, LIDAR system 100 may include at least one optional optical window 124 for directing light projected towards field of view 120 and/or receiving light reflected from objects in field of view 120. Optional optical window 124 may serve different purposes, such as collimation of the projected light and focusing of the reflected light. In one embodiment, optional optical window 124 may be an opening, a flat window, a lens, or any other type of optical window.

In the example LIDAR system represented by FIG. 1A, deflector 114 is configured to rotate about a scanning axis 119, which may be oriented generally in a vertical direction relative to vehicle 110. In some cases, deflector 114 can rotate or spin about axis 119 such that FOV 120 extends over a full 360 degrees relative to vehicle 110. In some examples, FOV 120 may extend less than 360 degrees relative to vehicle 110.

In some cases, deflector 114 may also be configured to rotate about a tilt axis 121. Rotation about tilt axis 121 may cause a light beam from light source 112 to be projected toward FOV 120 at different tilt angles. As a result, FOV 120 may extend over a predetermined vertical scan range related to the tilt angle range offered by deflector 114. In some cases, a vertical scan range 117 of LIDAR system 100 may be +/−5 degrees, +/−10 degrees, +/−20 degrees relative to the LIDAR system. Other scan ranges are also possible based on the configuration of the deflector 114. In some cases, after each rotation of the deflector about scan axis 119, deflector 114 may be tilted about tilt axis 121 by a predetermined incremental amount, such that each rotation of the deflector 114 may be associated with a different horizontally oriented scan line (e.g., scan lines 123) relative to FOV 120.

Consistent with the present disclosure, LIDAR system 100 may be used in autonomous or semi-autonomous road-vehicles (for example, cars, buses, vans, trucks and any other terrestrial vehicle). Autonomous road-vehicles with LIDAR system 100 may scan their environment and drive to a destination vehicle without human input. Similarly, LIDAR system 100 may also be used in autonomous/semi-autonomous aerial-vehicles (for example, UAV, drones, quadcopters, and any other airborne vehicle or device); or in an autonomous or semi-autonomous water vessel (e.g., boat, ship, submarine, or any other watercraft). Autonomous aerial-vehicles and water craft with LIDAR system 100 may scan their environment and navigate to a destination autonomously or using a remote human operator. According to one embodiment, vehicle 110 (either a road-vehicle, aerial-vehicle, or watercraft) may use LIDAR system 100 to aid in detecting and scanning the environment in which vehicle 110 is operating.

It should be noted that LIDAR system 100 or any of its components may be used together with any of the example embodiments and methods disclosed herein. Further, while some aspects of LIDAR system 100 are described relative to an exemplary vehicle-based LIDAR platform, LIDAR system 100, any of its components, or any of the processes described herein may be applicable to LIDAR systems of other platform types.

In some embodiments, LIDAR system 100 may include one or more scanning units 104 to scan the environment around vehicle 110. LIDAR system 100 may be attached or mounted to any part of vehicle 110. Sensing unit 106 may receive reflections from the surroundings of vehicle 110, and transfer reflections signals indicative of light reflected from objects in field of view 120 to processing unit 108. Consistent with the present disclosure, scanning units 104 may be mounted to or incorporated into any suitable location or position relative to vehicle 110 (e.g., on a roof, undercarriage, side panels, hood, trunk, etc.). In some cases, LIDAR system 100 may capture a complete surround view of the environment of vehicle 110. Thus, LIDAR system 100 may have a 360-degree horizontal field of view 120. In one example, as shown in FIG. 1A, LIDAR system 100 may include a single scanning unit 104 mounted on a roof vehicle 110. Alternatively, LIDAR system 100 may include multiple scanning units (e.g., two, three, four, or more scanning units 104) each with a field of few such that in the aggregate the horizontal field of view is covered by a 360-degree scan around vehicle 110. One skilled in the art will appreciate that LIDAR system 100 may include any number of scanning units 104 arranged in any manner, each with up to a 360 degree field of view, depending on the number of units employed. Moreover, a 360-degree horizontal field of view may be also obtained by mounting multiple LIDAR systems 100 on vehicle 110, each with a single scanning unit 104. It is nevertheless noted that the one or more LIDAR systems 100 do not have to provide a complete 360° field of view, and that narrower fields of view may be useful in some situations.

FIG. 1B is an image showing an exemplary point cloud output from a portion of a single scanning cycle of LIDAR system 100 mounted on vehicle 110 consistent with disclosed embodiments. Every gray dot in the image corresponds a certain spatial location in the environment around vehicle 110 from which a reflection of light generated by source 112 was detected by sensing unit 106. In addition to location, each gray dot may also be associated with different types of information, for example, range (based on time of flight calculations), intensity (e.g., how much light returns back from that location), reflectivity, proximity to other dots, etc. In one embodiment, LIDAR system 100 may generate a plurality of point-cloud data entries from detected reflections of multiple scanning cycles of the field of view to enable, for example, determining a point cloud model of the environment around vehicle 110.

FIG. 1C is an image showing a representation of another portion of a point cloud model determined from the output of LIDAR system 100. Consistent with disclosed embodiments, by processing the generated point-cloud data entries of the environment around vehicle 110, a surround-view image may be produced from the point cloud model. In one embodiment, the point cloud model may be provided to a feature extraction module, which processes the point cloud information to identify a plurality of features. Each feature may include data about different aspects of the point cloud and/or of objects in the environment around vehicle 110 (e.g., cars, trees, people, and roads). Features may have the same resolution of the point cloud model (i.e. having the same number of data points, optionally arranged into similar sized 2D arrays), or may have different resolutions. The features may be stored in any kind of data structure (e.g., raster, vector, 2D array, 1D array). In addition, virtual features, such as a representation of vehicle 110, border lines, or bounding boxes separating regions or objects in the image (e.g., as depicted in FIG. 1B), and icons representing one or more identified objects, may be overlaid on the representation of the point cloud model to form the final surround-view image. For example, a symbol of vehicle 110 may be overlaid at a center of the surround-view image.

The Projecting Unit

FIG. 2A illustrates an example of a bi-static configuration of LIDAR system 100 in which projecting unit 102 includes a single light source 112. The term “bi-static configuration” broadly refers to LIDAR systems configurations in which the projected light exiting the LIDAR system and the reflected light entering the LIDAR system pass through substantially different optical paths. In some embodiments, a bi-static configuration of LIDAR system 100 may include a separation of the optical paths by using completely different optical components, by using parallel but not fully separated optical components, or by using the same optical components for only part of the of the optical paths (optical components may include, for example, windows, lenses, mirrors, beam splitters, etc.). In the example depicted in FIG. 2A, the bi-static configuration includes a configuration where the outbound light and the inbound light pass through a single optical window 124 but scanning unit 104 includes two light deflectors, a first light deflector 114A for outbound light and a second light deflector 114B for inbound light (the inbound light in LIDAR system includes emitted light reflected from objects in the scene, and may also include ambient light arriving from other sources). In the examples depicted in FIGS. 2E and 2G, the bi-static configuration includes a configuration where the outbound light passes through a first optical window 124A, and the inbound light passes through a second optical window 1248.

In this embodiment, the components of LIDAR system 100 may be contained within a single housing, or may be divided among a plurality of housings (e.g., 200A and 200B). As shown, projecting unit 102 may include a single light source 112 that includes a laser diode 202A (or one or more laser diodes coupled together) configured to emit light (projected light 204). In one non-limiting example, the light projected by light source 112 may be at a wavelength between about 800 nm and 950 nm, have an average power between about 50 mW and about 500 mW, have a peak power between about 50 W and about 200 W, and a pulse width of between about 2 ns and about 100 ns. In addition, light source 112 may optionally be associated with optical assembly 202B used for manipulation of the light emitted by laser diode 202A (e.g., for collimation, focusing, etc.). It is noted that other types of light sources 112 may be used, and that the disclosure is not restricted to laser diodes. In addition, light source 112 may emit its light in different formats, such as light pulses, frequency modulated, continuous wave (CW), quasi-CW, or any other form corresponding to the particular light source employed. The projection format and other parameters may be changed by the light source from time to time based on different factors, such as instructions from processing unit 108. The projected light is projected towards an outbound deflector 114A that functions as a steering element for directing the projected light in field of view 120. In this example, scanning unit 104 also include a pivotable return deflector 1148 that direct photons (reflected light 206) reflected back from an object 208 within field of view 120 toward sensor 116. The reflected light is detected by sensor 116 and information about the object (e.g., the distance to object 212) is determined by processing unit 108. While FIG. 2A represents scanning along horizontal scan lines in alternating directions, in the case of the scanning system of FIG. 1A, the scanning of all horizontal scan lines will generally proceed in a common direction (e.g., as dictated by the rotational direction of deflector 114 about scan axis 119).

In the example of FIG. 2A, LIDAR system 100 is connected to a host 210. Consistent with the present disclosure, the term “host” refers to any computing environment that may interface with LIDAR system 100, it may be a vehicle system (e.g., part of vehicle 110), a testing system, a security system, a surveillance system, a traffic control system, an urban modelling system, or any system that monitors its surroundings. Such computing environment may include at least one processor and/or may be connected LIDAR system 100 via the cloud. In some embodiments, host 210 may also include interfaces to external devices such as camera and sensors configured to measure different characteristics of host 210 (e.g., acceleration, steering wheel deflection, reverse drive, etc.). Consistent with the present disclosure, LIDAR system 100 may be fixed to a stationary object associated with host 210 (e.g., a building, a tripod) or to a portable system associated with host 210 (e.g., a portable computer, a movie camera). Consistent with the present disclosure, LIDAR system 100 may be connected to host 210, to provide outputs of LIDAR system 100 (e.g., a 3D model, a reflectivity image) to host 210. Specifically, host 210 may use LIDAR system 100 to aid in detecting and scanning the environment of host 210 or any other environment. In addition, host 210 may integrate, synchronize or otherwise use together the outputs of LIDAR system 100 with outputs of other sensing systems (e.g., cameras, microphones, radar systems). In one example, LIDAR system 100 may be used by a security system.

LIDAR system 100 may also include a bus 212 (or other communication mechanisms) that interconnect subsystems and components for transferring information within LIDAR system 100. Optionally, bus 212 (or another communication mechanism) may be used for interconnecting LIDAR system 100 with host 210. In the example of FIG. 2A, processing unit 108 includes two processors 118 to regulate the operation of projecting unit 102, scanning unit 104, and sensing unit 106 in a coordinated manner based, at least partially, on information received from internal feedback of LIDAR system 100. In other words, processing unit 108 may be configured to dynamically operate LIDAR system 100 in a closed loop. A closed loop system is characterized by having feedback from at least one of the elements and updating one or more parameters based on the received feedback. Moreover, a closed loop system may receive feedback and update its own operation, at least partially, based on that feedback. A dynamic system or element is one that may be updated during operation.

According to some embodiments, scanning the environment around LIDAR system 100 may include illuminating field of view 120 with light pulses. The light pulses may have parameters such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. Scanning the environment around LIDAR system 100 may also include detecting and characterizing various aspects of the reflected light. Characteristics of the reflected light may include, for example: time-of-flight (i.e., time from emission until detection), instantaneous power (e.g., power signature), average power across entire return pulse, and photon distribution/signal over return pulse period. By comparing characteristics of a light pulse with characteristics of corresponding reflections, a distance and possibly a physical characteristic, such as reflected intensity of object 212 may be estimated. By repeating this process across multiple adjacent portions 122, in a predefined pattern (e.g., raster, Lissajous or other patterns) an entire scan of field of view 120 may be achieved. In some situations, LIDAR system 100 may direct light to only some of the portions 122 in field of view 120 at every scanning cycle. These portions may be adjacent to each other, but not necessarily so.

In another embodiment, LIDAR system 100 may include network interface 214 for communicating with host 210 (e.g., a vehicle controller). The communication between LIDAR system 100 and host 210 is represented by a dashed arrow. In one embodiment, network interface 214 may include an integrated service digital network (ISDN) card, cable modem, satellite modem, or a modem to provide a data communication connection to a corresponding type of telephone line. As another example, network interface 214 may include a local area network (LAN) card to provide a data communication connection to a compatible LAN. In another embodiment, network interface 214 may include an Ethernet port connected to radio frequency receivers and transmitters and/or optical (e.g., infrared) receivers and transmitters. The specific design and implementation of network interface 214 depends on the communications network(s) over which LIDAR system 100 and host 210 are intended to operate. For example, network interface 214 may be used, for example, to provide outputs of LIDAR system 100 to the external system, such as a 3D model, operational parameters of LIDAR system 100, and so on. In other embodiment, the communication unit may be used, for example, to receive instructions from the external system, to receive information regarding the inspected environment, to receive information from another sensor, etc.

FIG. 2B illustrates asymmetrical deflector 216 that may be part of LIDAR system 100. In the illustrated example, asymmetrical deflector 216 includes a reflective surface 218 (such as a mirror) and a one-way deflector 220. While not necessarily so, asymmetrical deflector 216 may optionally be a static deflector. Asymmetrical deflector 216 may be used in a monostatic configuration of LIDAR system 100, in order to allow a common optical path for transmission and for reception of light via the at least one deflector 114. However, typical asymmetrical deflectors such as beam splitters are characterized by energy losses, especially in the reception path, which may be more sensitive to power loses than the transmission path.

As depicted in FIG. 2B, LIDAR system 100 may include asymmetrical deflector 216 positioned in the transmission path, which includes one-way deflector 220 for separating between the transmitted and received light signals. Optionally, one-way deflector 220 may be substantially transparent to the transmission light and substantially reflective to the received light. The transmitted light is generated by projecting unit 102 and may travel through one-way deflector 220 to scanning unit 104 which deflects it towards the optical outlet. The received light arrives through the optical inlet, to the at least one deflecting element 114, which deflects the reflections signal into a separate path away from the light source and towards sensing unit 106. Optionally, asymmetrical deflector 216 may be combined with a polarized light source 112 which is linearly polarized with the same polarization axis as one-way deflector 220. Notably, the cross-section of the outbound light beam is much smaller than that of the reflections signals. Accordingly, LIDAR system 100 may include one or more optical components (e.g., lens, collimator) for focusing or otherwise manipulating the emitted polarized light beam to the dimensions of the asymmetrical deflector 216. In one embodiment, one-way deflector 220 may be a polarizing beam splitter that is virtually transparent to the polarized light beam.

Consistent with some embodiments, LIDAR system 100 may further include optics 222 (e.g., a quarter wave plate retarder) for modifying a polarization of the emitted light. For example, optics 222 may modify a linear polarization of the emitted light beam to circular polarization. Light reflected back to system 100 from the field of view would arrive back through deflector 114 to optics 222, bearing a circular polarization with a reversed handedness with respect to the transmitted light. Optics 222 would then convert the received reversed handedness polarization light to a linear polarization that is not on the same axis as that of the polarized beam splitter 216. As noted above, the received light-patch is larger than the transmitted light-patch, due to optical dispersion of the beam traversing through the distance to the target.

Some of the received light will impinge on one-way deflector 220 that will reflect the light towards sensor 106 with some power loss. However, another part of the received patch of light will fall on a reflective surface 218 which surrounds one-way deflector 220 (e.g., polarizing beam splitter slit). Reflective surface 218 will reflect the light towards sensing unit 106 with substantially zero power loss. One-way deflector 220 would reflect light that is composed of various polarization axes and directions that will eventually arrive at the detector. Optionally, sensing unit 106 may include sensor 116 that is agnostic to the laser polarization, and is primarily sensitive to the amount of impinging photons at a certain wavelength range.

It is noted that the proposed asymmetrical deflector 216 may provide superior performance when compared to a simple mirror with a passage hole in it. In a mirror with a hole, all of the reflected light which reaches the hole is lost to the detector. However, in deflector 216, one-way deflector 220 deflects a significant portion of that light (e.g., about 50%) toward the respective sensor 116. In LIDAR systems, the number photons reaching the LIDAR from remote distances is very limited, and therefore the improvement in photon capture rate is important.

According to some embodiments, a device for beam splitting and steering is described. A polarized beam may be emitted from a light source having a first polarization. The emitted beam may be directed to pass through a polarized beam splitter assembly. The polarized beam splitter assembly includes on a first side a one-directional slit and on an opposing side a mirror. The one-directional slit enables the polarized emitted beam to travel toward a quarter-wave-plate/wave-retarder which changes the emitted signal from a polarized signal to a linear signal (or vice versa) so that subsequently reflected beams cannot travel through the one-directional slit.

The Scanning Unit

FIG. 3 provides a diagrammatic representation of an exemplary LIDAR system 100 that mechanically scans the environment of LIDAR system 100. In this example, LIDAR system 100 may include a motor or other mechanisms for rotating housing 200 about the axis of the LIDAR system 100 (e.g., scan axis 119, as shown in FIG. 1A). Alternatively, the motor (or other mechanism) may mechanically rotate a rigid structure associated with LIDAR system 100 that houses deflector 114, among other components. In some cases, the rotated structure may also include one or more light sources 112 and one or more sensors 116, but in other cases, light sources 112 and sensors 116 may be maintained in a fixed, non-rotating position. As described above, projecting unit 102 may include at least one light source 112 configured to project light emission. The projected light emission may travel along an outbound path towards field of view 120. Specifically, the projected light emission may be reflected by deflector 114A through an exit aperture 314 when projected light 204 travel towards optional optical window 124. The reflected light emission may travel along a return path from object 208 towards sensing unit 106. For example, the reflected light 206 may be reflected by deflector 1148 when reflected light 206 travels towards sensing unit 106. A person skilled in the art would appreciate that a LIDAR system with a rotation mechanism for synchronically rotating one or more light sources or one or more sensors, may use this synchronized rotation instead of (or in addition to) steering an internal light deflector. In some cases, only a single deflector 114 may be included, and both the transmission light paths (Tx) and return light paths (Rx) may be incident upon deflector 114.

In embodiments in which the scanning of field of view 120 is mechanical, the projected light emission may be directed to exit aperture 314 that is part of a wall 316 separating projecting unit 102 from other parts of LIDAR system 100. In some examples, wall 316 can be formed from a transparent material (e.g., glass) coated with a reflective material to form deflector 114B. In this example, exit aperture 314 may correspond to the portion of wall 316 that is not coated by the reflective material. Additionally or alternatively, exit aperture 314 may include a hole or cut-away in the wall 316. Reflected light 206 may be reflected by deflector 114B and directed towards an entrance aperture 318 of sensing unit 106. In some examples, an entrance aperture 318 may include a filtering window configured to allow wavelengths in a certain wavelength range to enter sensing unit 106 and attenuate other wavelengths. The reflections from an object in field of view 120 may be reflected by deflector 114B and made incident upon sensor 116. By comparing several properties of reflected light 206 with projected light 204, at least one aspect of the object may be determined. For example, by comparing a time when projected light 204 was emitted by light source 112 and a time when sensor 116 received reflected light 206, a distance between the object and LIDAR system 100 may be determined. In some examples, other aspects of the object, such as shape, color, material, etc. may also be determined.

In some examples, the LIDAR system 100 (or part thereof, including at least one light source 112 and at least one sensor 116) may be rotated about at least one axis to determine a three-dimensional map of the surroundings of the LIDAR system 100. For example, the LIDAR system 100 may be rotated about a substantially vertical axis (e.g., scan axis 119) as illustrated by arrow 320 in order to scan field of view 120. Although FIG. 3 illustrates that the LIDAR system 100 is rotated clock-wise about the axis as illustrated by the arrow 320, additionally or alternatively, the LIDAR system 100 may be rotated in a counter clockwise direction. In some examples, the LIDAR system 100 may be rotated 360 degrees about the vertical axis. In other examples, the LIDAR system 100 may be rotated back and forth along a sector smaller than 360-degree of the LIDAR system 100. For example, the LIDAR system 100 may be mounted on a platform that wobbles back and forth about the axis without making a complete rotation.

The Sensing Unit

FIGS. 4A-4C depict various configurations of sensing unit 106 and its role in LIDAR system 100. Specifically, FIG. 4A is a diagram illustrating an example sensing unit 106 with a detector array, FIG. 4B is a diagram illustrating a lens array associated with sensor 116, and FIG. 4C includes three diagrams illustrating the lens structure. One skilled in the art will appreciate that the depicted configurations of sensing unit 106 are exemplary only and may have numerous alternative variations and modifications consistent with the principles of this disclosure.

FIG. 4A illustrates an example of sensing unit 106 with detector array 400. In this example, at least one sensor 116 includes detector array 400. LIDAR system 100 is configured to detect objects (e.g., bicycle 208A and cloud 208B) in field of view 120 located at different distances from LIDAR system 100 (could be meters or more). Objects 208 may be a solid object (e.g., a road, a tree, a car, a person), fluid object (e.g., fog, water, atmosphere particles), or object of another type (e.g., dust or a powdery illuminated object). When the photons emitted from light source 112 hit object 208 they either reflect, refract, or get absorbed. In some cases, as shown in the FIG. 4A, only a portion of the photons reflected from object 208A may enter optional optical window 124. As each ˜15 cm change in distance results in a travel time difference of 1 ns (since the photons travel at the speed of light to and from object 208), the time differences between the travel times of different photons hitting the different objects may be detectable by a time-of-flight sensor with sufficiently quick response.

Sensor 116 includes a plurality of detection elements 402 for detecting photons of a photonic pulse reflected back from field of view 120. The detection elements may all be included in detector array 400, which may have a rectangular arrangement (e.g., as shown) or any other arrangement. Detection elements 402 may operate concurrently or partially concurrently with each other. Specifically, each detection element 402 may issue detection information for every sampling duration (e.g., every 1 nanosecond). In one example, detector array 400 may be a SiPM (Silicon photomultipliers) which is a solid-state single-photon-sensitive device built from an array of single photon avalanche diodes (SPADs, serving as detection elements 402) on a common silicon substrate. Similar photomultipliers from other, non-silicon materials may also be used. Although a SiPM device works in digital/switching mode, the SiPM is an analog device because all the microcells are read in parallel, making it possible to generate signals within a dynamic range from a single photon to hundreds and thousands of photons detected by the different SPADs. As mentioned above, more than one type of sensor may be implemented (e.g., SiPM and APD). Possibly, sensing unit 106 may include at least one APD integrated into an SiPM array and/or at least one APD detector located next to a SiPM on a separate or common silicon substrate.

In one embodiment, detection elements 402 may be grouped into a plurality of regions or pixels 404. The regions are geometrical locations or environments within sensor 116 (e.g., within detector array 400)— and may be shaped in different shapes (e.g., rectangular as shown, squares, rings, and so on, or in any other shape). While not all of the individual detectors, which are included within the geometrical area of a region 404, necessarily belong to that region, in most cases they will not belong to other regions 404 covering other areas of the sensor 310—unless some overlap is desired in the seams between regions. As illustrated in FIG. 4A, the regions may be non-overlapping regions 404, but alternatively, they may overlap. Every region may be associated with a regional output circuitry 406 associated with that region. The regional output circuitry 406 may provide a region output signal of a corresponding group of detection elements 402. For example, the region of output circuitry 406 may be a summing circuit, but other forms of combined output of the individual detector into a unitary output (whether scalar, vector, or any other format) may be employed. Optionally, each region 404 is a single SiPM, but this is not necessarily so, and a region may be a sub-portion of a single SiPM, a group of several Si PMs, or even a combination of different types of detectors.

In the illustrated example, processing unit 108 is located in a separate housing 200B (within or outside) host 210 (e.g., within vehicle 110), and sensing unit 106 may include a dedicated processor 408 for analyzing the reflected light. Alternatively, processing unit 108 may be used for analyzing reflected light 206. It is noted that LIDAR system 100 may be implemented multiple housings in other ways than the illustrated example. For example, light deflector 114 may be located in a different housing than projecting unit 102 and/or sensing module 106. In one embodiment, LIDAR system 100 may include multiple housings connected to each other in different ways, such as: electric wire connection, wireless connection (e.g., RF connection), fiber optics cable, and any combination of the above.

In one embodiment, analyzing reflected light 206 may include determining a time of flight for reflected light 206, based on outputs of individual detectors of different regions. Optionally, processor 408 may be configured to determine the time of flight for reflected light 206 based on the plurality of regions of output signals. In addition to the time of flight, processing unit 108 may analyze reflected light 206 to determine the average power across an entire return pulse, and the photon distribution/signal may be determined over the return pulse period (“pulse shape”). In the illustrated example, the outputs of any detection elements 402 may not be transmitted directly to processor 408, but rather combined (e.g., summed) with signals of other detectors of the region 404 before being passed to processor 408. However, this is only an example and the circuitry of sensor 116 may transmit information from a detection element 402 to processor 408 via other routes (not via a region output circuitry 406).

Sensor 116 may be composed of a matrix (e.g., 4×6) of pixels 404. In one embodiment, a pixel size may be about 1×1 mm. Sensor 116 may be two-dimensional in the sense that it has more than one set (e.g., row, column) of pixels 404 in two non-parallel axes (e.g., orthogonal axes, as exemplified in the illustrated examples). The number of pixels 404 in sensor 116 may vary between differing implementations, e.g. depending on the desired resolution, signal to noise ratio (SNR), desired detection distance, and so on. For example, sensor 116 may have anywhere between 5 and 5,000 pixels. In another example (not shown in the figure), sensor 116 may be a one-dimensional matrix (e.g., 1×4, 1×8, etc. pixels).

It is noted that each detector pixel 404 may include a plurality of detection elements 402, such as Avalanche Photo Diodes (APD), Single Photon Avalanche Diodes (SPADs), combination of Avalanche Photo Diodes (APD) and Single Photon Avalanche Diodes (SPADs) or detecting elements that measure both the time of flight from a laser pulse transmission event to the reception event and the intensity of the received photons. For example, each pixel 410 may include anywhere between 20 and 5,000 SPADs. The outputs of detection elements 402 in each detector pixel 404 may be summed, averaged, or otherwise combined to provide a unified pixel output.

According to some embodiments, measurements from each detector pixel 404 may enable determination of the time of flight from a light pulse emission event to the reception event and the intensity of the received photons. The reception event may be the result of the light pulse being reflected from object 208. The time of flight may be a timestamp value that represents the distance of the reflecting object to optional optical window 124. Time of flight values may be realized by photon detection and counting methods, such as Time Correlated Single Photon Counters (TCSPC), analog methods for photon detection such as signal integration and qualification (via analog to digital converters or plain comparators) or otherwise.

In some embodiments, during a scanning cycle, each instantaneous position of at least one light deflector 114 may be associated with a particular portion 122 of field of view 120. The design of sensor 116 enables an association between the reflected light from a single portion of field of view 120 and multiple detector pixels 404. Therefore, the scanning resolution of LIDAR system may be represented by the number of instantaneous positions (per scanning cycle) times the number of pixels 404 in sensor 116. The information from each pixel 404 represents the basic data element from which the captured field of view in the three-dimensional space is built. This may include, for example, the basic element of a point cloud representation, with a spatial position and time of flight/range value. In one embodiment, the reflections from a single portion of field of view 120 that are detected by multiple pixels 404 may be returning from different objects located in the single portion of field of view 120. For example, the single portion of field of view 120 may be greater than 50×50 cm at the far field, which can include two, three, or more objects partly covered by each other.

FIG. 4B is a cross section diagram of a part of an example sensor 116, in accordance with examples of the presently disclosed subject matter. The illustrated part of sensor 116 includes a part of a detector array 400 which includes four detection elements 402 (e.g., four SPADs, four APDs). Detector array 400 may be a photodetector sensor realized in complementary metal-oxide-semiconductor (CMOS). Each of the detection elements 402 has a sensitive area, which is positioned within a substrate surrounding. While not necessarily so, sensor 116 may be used in a monostatic LiDAR system having a narrow field of view (e.g., because scanning unit 104 scans different parts of the field of view at different times). The narrow field of view for the incoming light beam—if implemented—eliminates the problem of out-of-focus imaging. As exemplified in FIG. 4B, sensor 116 may include a plurality of lenses 422 (e.g., microlenses), each lens 422 may direct incident light toward a different detection element 402 (e.g., toward an active area of detection element 402), which may be usable when out-of-focus imaging is not an issue. Lenses 422 may be used for increasing an optical fill factor and sensitivity of detector array 400, because most of the light that reaches sensor 116 may be deflected toward the active areas of detection elements 402.

Detector array 400, as exemplified in FIG. 4B, may include several layers built into the silicon substrate by various methods (e.g., implant) resulting in a sensitive area, contact elements to the metal layers and isolation elements (e.g., shallow trench implant STI, guard rings, optical trenches, etc.). The sensitive area may be a volumetric element in the CMOS detector that enables the optical conversion of incoming photons into a current flow given an adequate voltage bias is applied to the device. In the case of a APD/SPAD, the sensitive area would be a combination of an electrical field that pulls electrons created by photon absorption towards a multiplication area where a photon induced electron is amplified creating a breakdown avalanche of multiplied electrons.

A front side illuminated detector (e.g., as illustrated in FIG. 4B) has the input optical port at the same side as the metal layers residing on top of the semiconductor (Silicon). The metal layers are required to realize the electrical connections of each individual photodetector element (e.g., anode and cathode) with various elements such as: bias voltage, quenching/ballast elements, and other photodetectors in a common array. The optical port through which the photons impinge upon the detector sensitive area is comprised of a passage through the metal layer. It is noted that passage of light from some directions through this passage may be blocked by one or more metal layers (e.g., metal layer ML6, as illustrated for the leftmost detector elements 402 in FIG. 4B). Such blockage reduces the total optical light absorbing efficiency of the detector.

FIG. 4C illustrates three detection elements 402, each with an associated lens 422, in accordance with examples of the presenting disclosed subject matter. Each of the three detection elements of FIG. 4C, denoted 402(1), 402(2), and 402(3), illustrates a lens configuration which may be implemented in associated with one or more of the detecting elements 402 of sensor 116. It is noted that combinations of these lens configurations may also be implemented.

In the lens configuration illustrated with regards to detection element 402(1), a focal point of the associated lens 422 may be located above the semiconductor surface. Optionally, openings in different metal layers of the detection element may have different sizes aligned with the cone of focusing light generated by the associated lens 422. Such a structure may improve the signal-to-noise and resolution of the array 400 as a whole device. Large metal layers may be important for delivery of power and ground shielding. This approach may be useful, e.g., with a monostatic LiDAR design with a narrow field of view where the incoming light beam is comprised of parallel rays and the imaging focus does not have any consequence to the detected signal.

In the lens configuration illustrated with regards to detection element 402(2), an efficiency of photon detection by the detection elements 402 may be improved by identifying a sweet spot. Specifically, a photodetector implemented in CMOS may have a sweet spot in the sensitive volume area where the probability of a photon creating an avalanche effect is the highest. Therefore, a focal point of lens 422 may be positioned inside the sensitive volume area at the sweet spot location, as demonstrated by detection elements 402(2). The lens shape and distance from the focal point may take into account the refractive indices of all the elements the laser beam is passing along the way from the lens to the sensitive sweet spot location buried in the semiconductor material.

In the lens configuration illustrated with regards to the detection element on the right of FIG. 4C, an efficiency of photon absorption in the semiconductor material may be improved using a diffuser and reflective elements. Specifically, a near IR wavelength requires a significantly long path of silicon material in order to achieve a high probability of absorbing a photon that travels through. In a typical lens configuration, a photon may traverse the sensitive area and may not be absorbed into a detectable electron. A long absorption path that improves the probability for a photon to create an electron renders the size of the sensitive area towards less practical dimensions (tens of um for example) for a CMOS device fabricated with typical foundry processes. The rightmost detector element in FIG. 4C demonstrates a technique for processing incoming photons. The associated lens 422 focuses the incoming light onto a diffuser element 424. In one embodiment, light sensor 116 may further include a diffuser located in the gap distant from the outer surface of at least some of the detectors. For example, diffuser 424 may steer the light beam sideways (e.g., as perpendicular as possible) towards the sensitive area and the reflective optical trenches 426. The diffuser is located at the focal point, above the focal point, or below the focal point. In this embodiment, the incoming light may be focused on a specific location where a diffuser element is located. Optionally, detector element 422 is designed to optically avoid the inactive areas where a photon induced electron may get lost and reduce the effective detection efficiency. Reflective optical trenches 426 (or other forms of optically reflective structures) cause the photons to bounce back and forth across the sensitive area, thus increasing the likelihood of detection. Ideally, the photons will get trapped in a cavity consisting of the sensitive area and the reflective trenches indefinitely until the photon is absorbed and creates an electron/hole pair.

Consistent with the present disclosure, a long path is created for the impinging photons to be absorbed and contribute to a higher probability of detection. Optical trenches may also be implemented in detecting element 422 for reducing cross talk effects of parasitic photons created during an avalanche that may leak to other detectors and cause false detection events. According to some embodiments, a photo detector array may be optimized so that a higher yield of the received signal is utilized, meaning, that as much of the received signal is received and less of the signal is lost to internal degradation of the signal. The photo detector array may be improved by: (a) moving the focal point at a location above the semiconductor surface, optionally by designing the metal layers above the substrate appropriately; (b) by steering the focal point to the most responsive/sensitive area (or “sweet spot”) of the substrate and (c) adding a diffuser above the substrate to steer the signal toward the “sweet spot” and/or adding reflective material to the trenches so that deflected signals are reflected back to the “sweet spot.”

While in some lens configurations, lens 422 may be positioned so that its focal point is above a center of the corresponding detection element 402, it is noted that this is not necessarily so. In other lens configuration, a position of the focal point of the lens 422 with respect to a center of the corresponding detection element 402 is shifted based on a distance of the respective detection element 402 from a center of the detection array 400. This may be useful in relatively larger detection arrays 400, in which detector elements further from the center receive light in angles which are increasingly off-axis. Shifting the location of the focal points (e.g., toward the center of detection array 400) allows correcting for the incidence angles. Specifically, shifting the location of the focal points (e.g., toward the center of detection array 400) allows correcting for the incidence angles while using substantially identical lenses 422 for all detection elements, which are positioned at the same angle with respect to a surface of the detector.

Adding an array of lenses 422 to an array of detection elements 402 may be useful when using a relatively small sensor 116 which covers only a small part of the field of view because in such a case, the reflection signals from the scene reach the detectors array 400 from substantially the same angle, and it is, therefore, easy to focus all the light onto individual detectors. It is also noted, that in one embodiment, lenses 422 may be used in LIDAR system 100 for favoring about increasing the overall probability of detection of the entire array 400 (preventing photons from being “wasted” in the dead area between detectors/sub-detectors) at the expense of spatial distinctiveness. This embodiment is in contrast to prior art implementations such as CMOS RGB camera, which prioritize spatial distinctiveness (i.e., light that propagates in the direction of detection element A is not allowed to be directed by the lens toward detection element B, that is, to “bleed” to another detection element of the array). Optionally, sensor 116 includes an array of lens 422, each being correlated to a corresponding detection element 402, while at least one of the lenses 422 deflects light which propagates to a first detection element 402 toward a second detection element 402 (thereby it may increase the overall probability of detection of the entire array).

Specifically, consistent with some embodiments of the present disclosure, light sensor 116 may include an array of light detectors (e.g., detector array 400), each light detector (e.g., detector 410) being configured to cause an electric current to flow when light passes through an outer surface of a respective detector. In addition, light sensor 116 may include at least one micro-lens configured to direct light toward the array of light detectors, the at least one micro-lens having a focal point. Light sensor 116 may further include at least one layer of conductive material interposed between the at least one micro-lens and the array of light detectors and having a gap therein to permit light to pass from the at least one micro-lens to the array, the at least one layer being sized to maintain a space between the at least one micro-lens and the array to cause the focal point (e.g., the focal point may be a plane) to be located in the gap, at a location spaced from the detecting surfaces of the array of light detectors.

In related embodiments, each detector may include a plurality of Single Photon Avalanche Diodes (SPADs) or a plurality of Avalanche Photo Diodes (APD). The conductive material may be a multi-layer metal constriction, and the at least one layer of conductive material may be electrically connected to detectors in the array. In one example, the at least one layer of conductive material includes a plurality of layers. In addition, the gap may be shaped to converge from the at least one micro-lens toward the focal point, and to diverge from a region of the focal point toward the array. In other embodiments, light sensor 116 may further include at least one reflector adjacent each photo detector. In one embodiment, a plurality of micro-lenses may be arranged in a lens array and the plurality of detectors may be arranged in a detector array. In another embodiment, the plurality of micro-lenses may include a single lens configured to project light to a plurality of detectors in the array.

The Processing Unit

FIGS. 5A-5C depict different functionalities of processing units 108 in accordance with some embodiments of the present disclosure. Specifically, FIG. 5A is a diagram illustrating emission patterns in a single frame-time for a single portion of the field of view, FIG. 5B is a diagram illustrating emission scheme in a single frame-time for the whole field of view, and. FIG. 5C is a diagram illustrating light emission projected towards field of view during a single scanning cycle.

FIG. 5A illustrates four examples of emission patterns in a single frame-time for a single portion 122 of field of view 120 associated with an instantaneous position of light deflector 114 (e.g., a specific rotational angle about axis 119 and a specific tilt angle about tilt axis 121). Consistent with embodiments of the present disclosure, processing unit 108 may control at least one light source 112 and light deflector 114 (or coordinate the operation of at least one light source 112 and at least one light deflector 114) in a manner enabling light flux to vary over a scan of field of view 120. Consistent with other embodiments, processing unit 108 may control only at least one light source 112 and light deflector 114 may be moved or pivoted in a fixed predefined pattern.

Diagrams A-D in FIG. 5A depict the power of light emitted towards a single portion 122 of field of view 120 over time. In Diagram A, processor 118 may control the operation of light source 112 in a manner such that during scanning of field of view 120 an initial light emission is projected toward portion 122 of field of view 120. When projecting unit 102 includes a pulsed-light light source, the initial light emission may include one or more initial pulses (also referred to as “pilot pulses”). Processing unit 108 may receive from sensor 116 pilot information about reflections associated with the initial light emission. In one embodiment, the pilot information may be represented as a single signal based on the outputs of one or more detectors (e.g., one or more SPADs, one or more APDs, one or more SiPMs, etc.) or as a plurality of signals based on the outputs of multiple detectors. In one example, the pilot information may include analog and/or digital information. In another example, the pilot information may include a single value and/or a plurality of values (e.g., for different times and/or parts of the segment).

Based on information about reflections associated with the initial light emission, processing unit 108 may be configured to determine the type of subsequent light emission to be projected towards portion 122 of field of view 120. The determined subsequent light emission for the particular portion of field of view 120 may be made during the same scanning cycle (i.e., in the same frame) or in a subsequent scanning cycle (i.e., in a subsequent frame).

In Diagram B, processor 118 may control the operation of light source 112 in a manner such that during scanning of field of view 120 light pulses in different intensities are projected towards a single portion 122 of field of view 120. In one embodiment, LIDAR system 100 may be operable to generate depth maps of one or more different types, such as any one or more of the following types: point cloud model, polygon mesh, depth image (holding depth information for each pixel of an image or of a 2D array), or any other type of 3D model of a scene. The sequence of depth maps may be a temporal sequence, in which different depth maps are generated at a different time. Each depth map of the sequence associated with a scanning cycle (interchangeably “frame”) may be generated within the duration of a corresponding subsequent frame-time. In one example, a typical frame-time may last less than a second. In some embodiments, LIDAR system 100 may have a fixed frame rate (e.g., 10 frames per second, 25 frames per second, 50 frames per second) or the frame rate may be dynamic. In other embodiments, the frame-times of different frames may not be identical across the sequence. For example, LIDAR system 100 may implement a 10 frames-per-second rate that includes generating a first depth map in 100 milliseconds (the average), a second frame in 92 milliseconds, a third frame at 142 milliseconds, and so on.

In Diagram C, processor 118 may control the operation of light source 112 in a manner such that during scanning of field of view 120 light pulses associated with different durations are projected towards a single portion 122 of field of view 120. In one embodiment, LIDAR system 100 may be operable to generate a different number of pulses in each frame. The number of pulses may vary between 0 to 32 pulses (e.g., 1, 5, 12, 28, or more pulses) and may be based on information derived from previous emissions. The time between light pulses may depend on desired detection range and can be between 500 ns and 5000 ns. In one example, processing unit 108 may receive from sensor 116 information about reflections associated with each light-pulse. Based on the information (or the lack of information), processing unit 108 may determine if additional light pulses are needed. It is noted that the durations of the processing times and the emission times in diagrams A-D are not in-scale. Specifically, the processing time may be substantially longer than the emission time. In diagram D, projecting unit 102 may include a continuous-wave light source. In one embodiment, the initial light emission may include a period of time where light is emitted and the subsequent emission may be a continuation of the initial emission, or there may be a discontinuity. In one embodiment, the intensity of the continuous emission may change over time.

Consistent with some embodiments of the present disclosure, the emission pattern may be determined per each portion of field of view 120. In other words, processor 118 may control the emission of light to allow differentiation in the illumination of different portions of field of view 120. In one example, processor 118 may determine the emission pattern for a single portion 122 of field of view 120, based on detection of reflected light from the same scanning cycle (e.g., the initial emission), which makes LIDAR system 100 extremely dynamic. In another example, processor 118 may determine the emission pattern for a single portion 122 of field of view 120, based on detection of reflected light from a previous scanning cycle. The differences in the patterns of the subsequent emissions may result from determining different values for light-source parameters for the subsequent emission, such as any one of the following:

a. Overall energy of the subsequent emission.

b. Energy profile of the subsequent emission.

c. A number of light-pulse-repetition per frame.

d. Light modulation characteristics such as duration, rate, peak, average power, and pulse shape.

e. Wave properties of the subsequent emission, such as polarization, wavelength, etc.

Consistent with the present disclosure, the differentiation in the subsequent emissions may be put to different uses. In one example, it is possible to limit emitted power levels in one portion of field of view 120 where safety is a consideration, while emitting higher power levels (thus improving signal-to-noise ratio and detection range) for other portions of field of view 120. This is relevant for eye safety, but may also be relevant for skin safety, safety of optical systems, safety of sensitive materials, and more. In another example, it is possible to direct more energy towards portions of field of view 120 where it will be of greater use (e.g., regions of interest, further distanced targets, low reflection targets, etc.) while limiting the lighting energy to other portions of field of view 120 based on detection results from the same frame or previous frame. It is noted that processing unit 108 may process detected signals from a single instantaneous field of view several times within a single scanning frame time; for example, subsequent emission may be determined upon after every pulse emitted, or after a number of pulses emitted.

FIG. 5B illustrates three examples of emission schemes in a single frame-time for field of view 120. Consistent with embodiments of the present disclosure, at least on processing unit 108 may use obtained information to dynamically adjust the operational mode of LIDAR system 100 and/or determine values of parameters of specific components of LIDAR system 100. The obtained information may be determined from processing data captured in field of view 120, or received (directly or indirectly) from host 210. Processing unit 108 may use the obtained information to determine a scanning scheme for scanning the different portions of field of view 120. The obtained information may include a current light condition, a current weather condition, a current driving environment of the host vehicle, a current location of the host vehicle, a current trajectory of the host vehicle, a current topography of road surrounding the host vehicle, or any other condition or object detectable through light reflection. In some embodiments, the determined scanning scheme may include at least one of the following: (a) a designation of portions within field of view 120 to be actively scanned as part of a scanning cycle, (b) a projecting plan for projecting unit 102 that defines the light emission profile at different portions of field of view 120; (c) a deflecting plan for scanning unit 104 that defines, for example, a deflection direction, frequency, and designating idle elements within a reflector array; and (d) a detection plan for sensing unit 106 that defines the detectors sensitivity or responsivity pattern.

In addition, processing unit 108 may determine the scanning scheme at least partially by obtaining an identification of at least one region of interest within the field of view 120 and at least one region of non-interest within the field of view 120. In some embodiments, processing unit 108 may determine the scanning scheme at least partially by obtaining an identification of at least one region of high interest within the field of view 120 and at least one region of lower-interest within the field of view 120. The identification of the at least one region of interest within the field of view 120 may be determined, for example, from processing data captured in field of view 120, based on data of another sensor (e.g., camera, GPS), received (directly or indirectly) from host 210, or any combination of the above. In some embodiments, the identification of at least one region of interest may include identification of portions, areas, sections, pixels, or objects within field of view 120 that are important to monitor. Examples of areas that may be identified as regions of interest may include, crosswalks, moving objects, people, nearby vehicles or any other environmental condition or object that may be helpful in vehicle navigation. Examples of areas that may be identified as regions of non-interest (or lower-interest) may be static (non-moving) far-away buildings, a skyline, an area above the horizon and objects in the field of view. Upon obtaining the identification of at least one region of interest within the field of view 120, processing unit 108 may determine the scanning scheme or change an existing scanning scheme. Further to determining or changing the light-source parameters (as described above), processing unit 108 may allocate detector resources based on the identification of the at least one region of interest. In one example, to reduce noise, processing unit 108 may activate detectors 410 where a region of interest is expected and disable detectors 410 where regions of non-interest are expected. In another example, processing unit 108 may change the detector sensitivity, e.g., increasing sensor sensitivity for long range detection where the reflected power is low.

Diagrams A-C in FIG. 5B depict examples of different scanning schemes for scanning field of view 120. Each square in field of view 120 represents a different portion 122 associated with an instantaneous position of at least one light deflector 114. Legend 500 details the level of light flux represented by the filling pattern of the squares. Diagram A depicts a first scanning scheme in which all of the portions have the same importance/priority and a default light flux is allocated to them. The first scanning scheme may be utilized in a start-up phase or periodically interleaved with another scanning scheme to monitor the whole field of view for unexpected/new objects. In one example, the light source parameters in the first scanning scheme may be configured to generate light pulses at constant amplitudes. Diagram B depicts a second scanning scheme in which a portion of field of view 120 is allocated with high light flux while the rest of field of view 120 is allocated with default light flux and low light flux. The portions of field of view 120 that are the least interesting may be allocated with low light flux. Diagram C depicts a third scanning scheme in which a compact vehicle and a bus (see silhouettes) are identified in field of view 120. In this scanning scheme, the edges of the vehicle and bus may be tracked with high power and the central mass of the vehicle and bus may be allocated with less light flux (or no light flux). Such light flux allocation enables concentration of more of the optical budget on the edges of the identified objects and less on their center which have less importance.

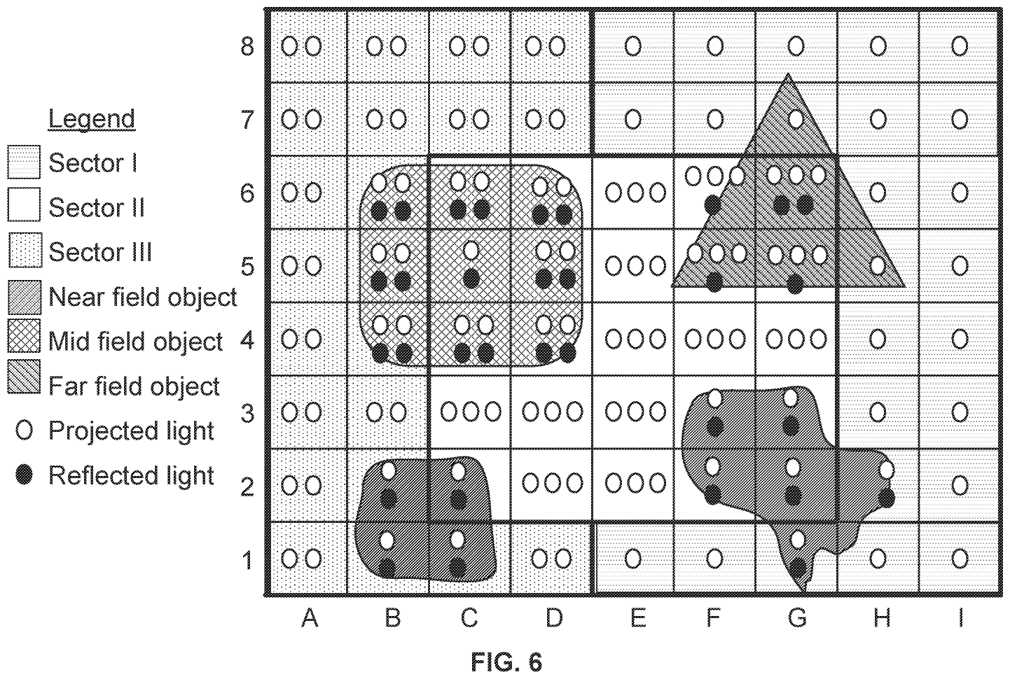

FIG. 6 illustrates the emission of light towards field of view 120 during a single scanning cycle. In the depicted example, a portion of field of view 120 is represented by an 8×9 matrix, where each of the 72 cells corresponds to a separate portion 122 associated with a different instantaneous position of at least one light deflector 114. In this exemplary scanning cycle, each portion includes one or more white dots that represent the number of light pulses projected toward that portion, and some portions include black dots that represent reflected light from that portion detected by sensor 116. As shown, field of view 120 is divided into three sectors: sector I on the right side of field of view 120, sector II in the middle of field of view 120, and sector III on the left side of field of view 120. In this exemplary scanning cycle, sector I was initially allocated with a single light pulse per portion; sector II, previously identified as a region of interest, was initially allocated with three light pulses per portion; and sector III was initially allocated with two light pulses per portion. Also as shown, scanning of field of view 120 reveals four objects 208: two free-form objects in the near field (e.g., between 5 and 50 meters), a rounded-square object in the mid field (e.g., between 50 and 150 meters), and a triangle object in the far field (e.g., between 150 and 500 meters). While the discussion of FIG. 6 uses number of pulses as an example of light flux allocation, it is noted that light flux allocation to different parts of the field of view may also be implemented in other ways such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. The illustration of the light emission as a single scanning cycle in FIG. 6 demonstrates different capabilities of LIDAR system 100. In a first embodiment, processor 118 is configured to use two light pulses to detect a first object (e.g., the rounded-square object) at a first distance, and to use three light pulses to detect a second object (e.g., the triangle object) at a second distance greater than the first distance. In a second embodiment, processor 118 is configured to allocate more light to portions of the field of view where a region of interest is identified. Specifically, in the present example, sector II was identified as a region of interest and accordingly it was allocated with three light pulses while the rest of field of view 120 was allocated with two or less light pulses. In a third embodiment, processor 118 is configured to control light source 112 in a manner such that only a single light pulse is projected toward to portions B1, B2, and C1 in FIG. 6, although they are part of sector III that was initially allocated with two light pulses per portion. This occurs because the processing unit 108 detected an object in the near field based on the first light pulse. Allocation of less than maximal amount of pulses may also be a result of other considerations. For examples, in at least some regions, detection of object at a first distance (e.g., a near field object) may result in reducing an overall amount of light emitted to this portion of field of view 120.

Additional details and examples on different components of LIDAR system 100 and their associated functionalities are included in Applicant's U.S. patent application Ser. No. 15/391,916 filed Dec. 28, 2016; Applicant's U.S. patent application Ser. No. 15/393,749 filed Dec. 29, 2016; Applicant's U.S. patent application Ser. No. 15/393,285 filed Dec. 29, 2016; and Applicant's U.S. patent application Ser. No. 15/393,593 filed Dec. 29, 2016, which are incorporated herein by reference in their entirety.

### Example Implementation: A Multibeam Spinning LIDAR

For various applications, multibeam laser scanning may provide certain advantages. For example, multibeam scanning can enable simultaneous scanning of multiple scan lines relative to the LIDAR FOV. In the context of automotive LIDAR systems, multibeam scanning may enable an enlarged vertical FOV, a higher frame capture rate or pixel rate, and/or variable resolution capabilities. In an automotive LIDAR system, as shown in FIG. 1A, LIDAR system 100 may be compact to allow for placement on top of vehicle 110, and may be designed to scan a 360 degree, 3-dimensional (3D) FOV in the vehicle environment.

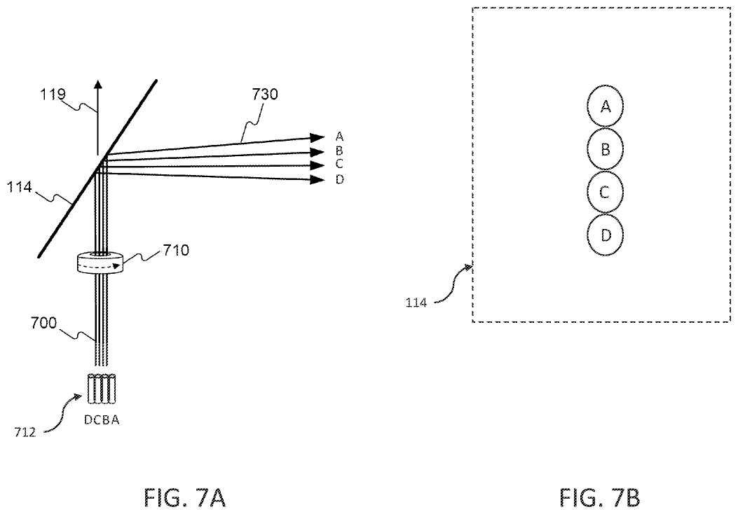

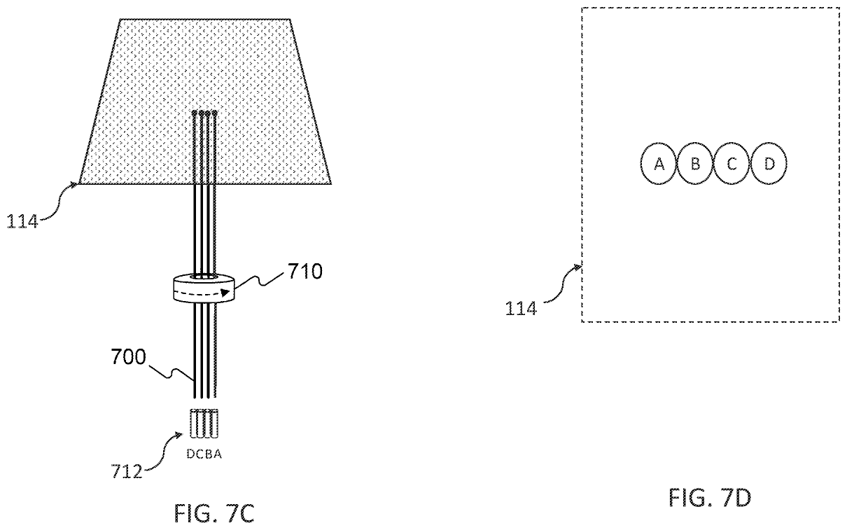

FIGS. 7A-7D provide conceptual representations of a LIDAR system including a multibeam light source 712 and a rotatable deflector 114. In the example of FIG. 7A, the rotatable deflector may be rotated using a spinner that may include, for example, various types of servo motors, stepper motors, DC motors, AC motors, actuators, linkages or other methods to rotate rotatable deflector 114. In the example shown, the direction of rotation of rotatable deflector 114 (from a top view) is counterclockwise about scan axis 119. Spinner 710 and, therefore, rotatable deflector 114 may also be configured to rotate in a clockwise direction. In this example, deflector 114 may include a rotatable folding mirror. Light source 712 may include an array of laser sources (e.g., sources A, B, C, and D) that generate multiple beams to form a multibeam array 700, which may be made incident upon rotatable deflector 114. In turn, rotatable deflector 114 deflects multibeam array 700 toward the LIDAR FOV 120 in the form of a projected multibeam array 730.

In FIG. 7A, deflector 114 is shown in a reference position of 0 degrees of rotation about scan axis 119. In this position, the column of beams included in multibeam array 700 are projected onto rotatable deflector 114 in a vertically oriented column, as shown in FIG. 7B. In turn, projected multibeam array 730 is projected toward the LIDAR FOV also in a vertically oriented column.

Rotating such a vertically oriented column of laser beams toward the FOV 120 can yield several benefits. For example, multiple horizontal scan lines (four lines in this particular example) can be scanned simultaneously, as rotatable deflector 114 spins about axis 119. Not only can such an arrangement enable larger vertical scan angles over the FOV 120, but it may also significantly reduce the time required to complete a single FOV scan (e.g., a single full scan of the LIDAR FOV 120—in this example, a 360 degrees in the horizontal by a predetermined angular height (e.g., +/−20 degrees, etc.) in the vertical dimension).

To reduce rotational inertia of the spinning components, which may spin at 5,000 rpm, 10,000 rpm, or more, system components, such as the processing unit 108, sensing unit 106, and light projecting unit 112 may be omitted from the spinning components. In some cases, the spinning components rotated by spinner 710 may include rotatable deflector 114 together with one or more optical components (e.g., collimators, lenses, etc.) but may omit other system components.

FIGS. 7C and 7D, however, represent a primary challenge resulting from the combination of a rotatable deflector (e.g., rotatable deflector 114) with a non-rotating, multibeam light source (e.g., light source 712). For example, FIG. 7C shows deflector 114 after it has rotated from its reference position of 0 degrees (FIG. 7A) to a position of 90 degrees of counterclockwise rotation about scan axis 119. In this orientation, the multibeam array 700 generated by light source 712 is no longer incident upon rotatable deflector 114 in a vertically oriented column, as shown in FIG. 7B. Rather, in the 90-degree orientation shown in FIG. 7A, the multibeam array 700 generated by light source 712 is incident upon rotatable deflector 114 in a horizontally oriented row, as shown in FIG. 7D. Note that in the 90 degree orientation, the reflecting face of deflector 114 is facing into the page. As a result, the projected multibeam array 730 directed to the LIDAR FOV 120 will also be arranged in a horizontal row configuration (specifically, the projected multibeam array 730 will have the same arrangement as the projections of beam 700 on deflector 114, as shown in FIG. 7D). This change in orientation from a vertical column (FIG. 7B) to a horizontal row (FIG. 7D) is problematic. For example, rather than scanning the FOV 120 with consistently spaced horizontal scan lines as deflector 114 rotates about scan axis 119, the changing orientation of projected multibeam 730, as deflector 114 rotates, would result in non-horizontal scan lines, continuous changes in spacing between the scan lines, and large gaps in the FOV 120 where no light is projected. Thus, such an arrangement would be undesirable for implementing a LIDAR system including a horizontal FOV of 360 degrees.

In contrast to the conceptual system of FIGS. 7A-7D, the disclosed LIDAR system achieves a constant, or nearly constant, orientation of a projected multibeam array from a LIDAR system including a multibeam light source combined with a rotatable deflector. As a result, the disclosed systems may effectively scan a 360 degree LIDAR FOV 120 using a series of horizontally oriented scan lines.

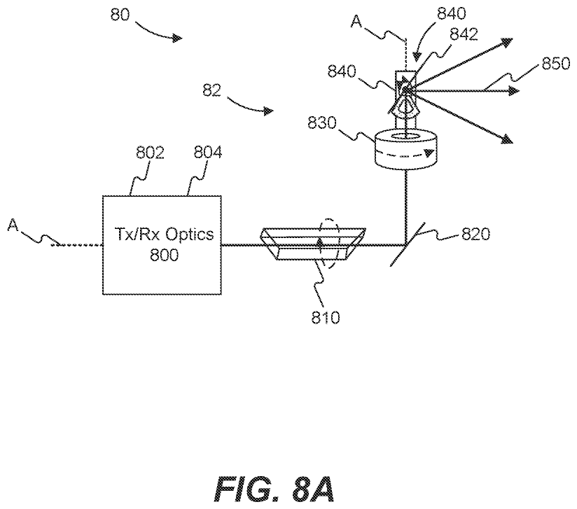

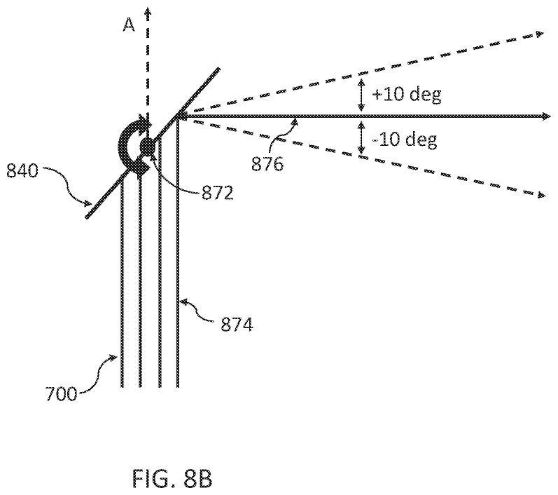

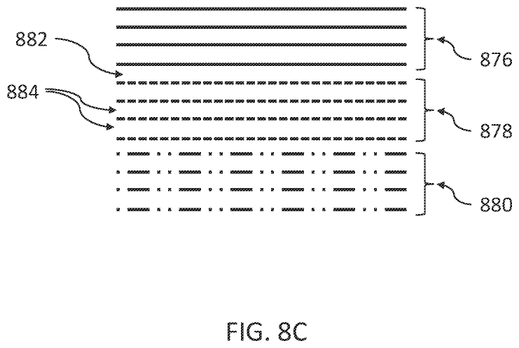

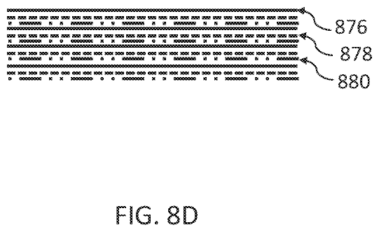

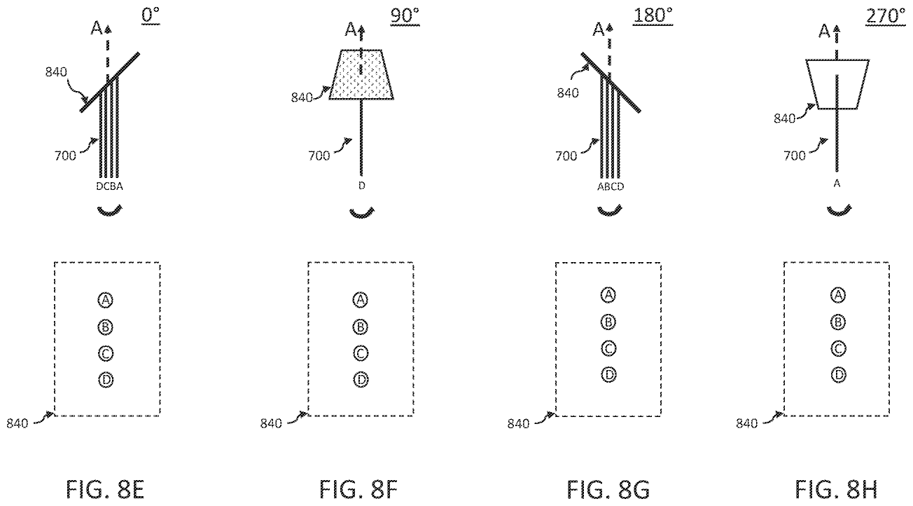

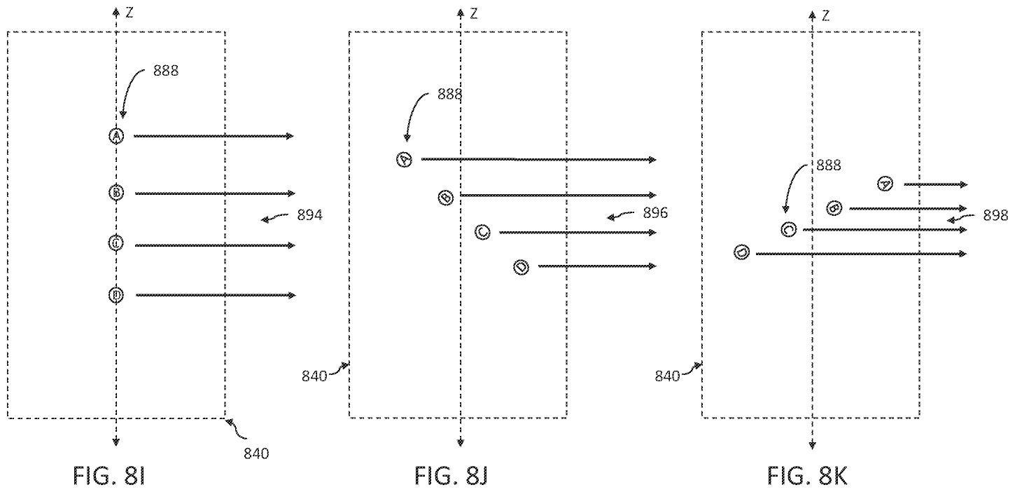

In an illustrative embodiment, the disclosed LIDAR system may provide a multibeam scanning LIDAR system with a substantially constant beam orientation pattern. With reference to FIG. 8A, illustrated is a schematic view of a LIDAR system for 360 degree scanning of a field of view using a multibeam array of laser beams having a constant, or substantially constant, beam orientation. In the example embodiment of FIG. 8A, a LIDAR system 80 includes TX/RX optics 800. In some examples, TX/RX optics 800 may include at least one light generator 802 (similar to light source 712) and at least one detector 804 (similar to detector 116). LIDAR system 80 may also include a beam rotator 810 and various combinations of a fixed folding mirror 820, a spinner 830, a deflector 840 and a mirror 842 that may produce a beam array 850 with substantially constant beam orientation. In the example shown in FIG. 8A, the beam rotator 810 is shown between TX/RX optics 800 and folding mirror 820. Other configurations, however, are also possible. For example, the beam rotator 810 may be placed anywhere along the optical path of the LIDAR system from which the orientation of the beam pattern relative to the deflector can be controlled. In some embodiments, the transmit and receive optical paths are different in which the projected light exiting the LIDAR system and the reflected light entering the LIDAR system pass through substantially different optical paths. It is to be appreciated that LIDAR system components may be positioned at different locations in the optical path of the LIDAR system to meet the requirements of applications consistent with disclosed embodiments.

As noted, light generator 802 may include a light source configured to generate a plurality of laser beams arranged in a multibeam pattern. In some cases, the multibeam pattern may be arranged in an M×N array, where N>1 and M may or may not be equal to N. The multibeam pattern may be arranged in a matrix or in a non-matrix configuration. For example, the multibeam pattern may be arranged as any two-dimensional arrangement of beam spots.

In some embodiments, light generator 802 may include a multichannel laser, such as a monolithic multichannel laser bar. The laser bar may include multiple diode lasers spaced apart on a single substrate by a predetermined distance. The laser source may include more than one emitting diode. By way of an example, the light source may include 8, 16 or 32 laser sources arranged in a one-dimensional (1D) array. The diodes may emit light at a wavelength of about 905 nm (850-950 nm), about 1550 nm (1450-1650 nm) or of any wavelength suitable for a particular application.

In some embodiments, the laser beams generated by light generator 802 may have circularly shaped cross sections. In other embodiments, however, light generator 802 may be configured to generate laser beams having non-circularly shaped cross sections (e.g., elliptical or elongated cross sections). In embodiments including one or more laser beams with elongated cross sections, the projected one or more laser beam may be scanned in a direction substantially perpendicular to a major axis of the elongated cross section. In such an orientation, scanning of the elongated spot laser beam will have maximum coverage available from the elongated spot laser beam. Other scan orientations relative to the major cross-sectional axis are also possible, however. For example, any scan direction of the elongated laser beam cross section relative to the FOV 120, other than parallel with the major axis of the cross section, will result in a scan coverage greater than the coverage offered by an elongated laser spot oriented such that the major axis is parallel to the scan direction. In some cases, the elongated laser beam spot may be selectively oriented such that the major axis of the beam spot cross section has an angle of greater than 0 degrees and up to +/−90 degrees relative to the beam scan direction.

LIDAR system 80 may include at least one sensor configured to receive laser light reflections from objects in the field of view 120 of the LIDAR system 80. The term “sensor” broadly includes any device, element, or system capable of measuring properties (e.g., power, frequency, phase, pulse timing, pulse duration) of electromagnetic waves and to generate an output relating to the measured properties. The at least one sensor may be configured to receive, via the rotatable deflector 840 and the beam rotator 810, laser light resulting from one or more of the plurality of laser beams reflected from at least one object in the field of view of the LIDAR system 80. The sensor may be comprised of a plurality of detectors 804 (within Tx/Rx Optics 800) that may receive light reflections from objects in the field of view of LIDAR system 80. Measurements from each detector 804 may enable determination of the time of flight from a light pulse emission event to the reception event. The intensity of received photons may also be determined based on the received laser light reflections. Various types of detectors may be used. For example, a detector 804 may include an array of sensors, such as, e.g., a multichannel SiPM (Silicon Photomultiplier) sensor array or SPAD (single-photon avalanche diode) array, or an APD (avalanche photodiodes) array. The detector may include an array of detector channels, SPADs, SIPMs, APDs, etc. In some cases, the detector 804 may be arranged in a 1D configuration. Detector 804 may also have any of the configurations or properties described above relative to, for example, detectors 116, 400, etc.

LIDAR system 80 may further comprise a scanning system 82, including at least a beam rotator 810, a spinner 830, and a rotatable deflector 840. In the illustrative embodiment shown in FIG. 8A, rotatable deflector 840 may be configured to rotate about a scanning axis A and may deflect the plurality of laser beams toward a field of view of the LIDAR system 80. In some embodiments, the scanning axis of the rotatable deflector 840 may be oriented substantially vertically (e.g., extending vertically relative to a vehicle 110 on which the LIDAR system is deployed, etc.). Rotatable deflector 840 may apply a mechanical deflection of the beam/s, an electronic deflection of the beam/s, or a combined mechanical and electronic deflection of the beam/s. For example, rotatable deflector 840 may comprise a mirror 842 for deflecting the multibeam array generated by light source 802. Rotation of rotatable deflector 840 about scan axis A results in horizontal scanning of projected multibeam array 850 across the LIDAR FOV 120. In some cases, the horizontal scanning occurs through a full 360 degrees as the rotatable deflector 840 spins.

Rotatable deflector 840 may include any type of structure or combination of structures capable of redirecting one or more incident light beams toward the FOV 120. In some embodiments, rotatable deflector 840 includes a folding mirror 842 configured to rotate about a substantially vertically oriented scan axis, A, as shown in FIG. 8A, that will result in a horizontal rotation scan of the FOV (e.g., including horizontal or nearly horizontal scan lines). Any suitable arrangement may be provided for providing the rotation of rotatable deflector 840 about axis A. In the example shown in FIG. 8A, a spinner 830 may be connected directly or indirectly to rotatable deflector 840 to rotate the rotatable deflector about scan axis A. Spinner 830 may include one or more electric motors and one or more platforms configured to attach to deflector 840 and impart rotational motion to deflector 840. The spin rate of spinner 830 may be selectable and controllable to vary scan rates associated with LIDAR system 80.

In some cases, rotatable deflector 840 rotates about scan axis A, but does not rotate about other axes, such as a horizontally oriented, vertical tilt axis. In such cases, tilting of beams of projected beam pattern 850 vertically relative to the FOV 120 is accomplished by one or more other components, discussed in more detail below. In some cases, however, rotatable deflector 840 not only rotates about scan axis A, but also is configured to rotate about one or more other axes. For example, as shown in FIG. 8B, in some example embodiments, rotatable deflector 840 may be configured to rotate both about a scan axis A and also about a tilt axis 872. In such cases, rotation about tilt axis 872 results in vertical shifting of the projected beams relative to FOV 120. With respect to beam 874, as shown in FIG. 8B, rotation of deflector 840 about tilt axis 872 may result in beam 874 being projected toward FOV 120 at various vertical tilt angles within a predetermined vertical scan range. In the particular example shown in FIG. 8B, rotatable deflector 840 is configured to rotate about tilt axis 872 such that beam 876 is projected toward FOV 120 and deflected along vertical tilt increments in a vertical range of 20 degrees (e.g., +/−10 degrees relative to the horizontal position of projected beam 876). Each of the beams of multibeam array 700 incident on deflector 840 will also be deflected in a similar manner, though such deflections have been omitted from FIG. 8B for clarity.

In some embodiments, eliminating wired control to adjust the position of the rotatable deflector 840 may be desirable. In these embodiments, a method using wireless communication (e.g. RDA Infrared comm, RF communication or the like) may be implemented between a processor and an actuator to control the vertical tilt angle of a rotatable deflector 840. The processor may transmit control wirelessly to the actuator to mechanically adjust the position of the rotatable deflector about the tilt axis 872, The processor may receive feedback via wireless communication from the actuator, or from one or more sensors associated with actuator and rotatable detector 840, indicating the tilt angle and/or other positional data of the rotatable deflector 840, By way of an example, the wireless control between the processor and the actuator may be provided by a dedicated wireless RF communication link that may provide a bi-directional wireless communication link with a data rate of 1 Mbps. In some embodiments, eliminating wired power to the actuator and rotatable deflector 840 may be desirable. In these embodiments, wireless power transmission may be used to provide power to an actuator to adjust the tilt angle of the rotatable deflector 840 about the tilt axis. By way of an example, wireless power may be transferred to the actuator of the rotatable deflector 840 configured to rotate about a tilt axis. In one example, approximately 0.5 to 2 Watts may be transferred from a wireless power source to the actuator by near field wireless power transfer (near-field electromagnetic coupling of cons, capacitive coupling or the like). In embodiments, wireless control and wireless power may be extended to control and/or to power additional components within the LIDAR system. Additionally or alternatively, the processor may control via wireless control or retrieve status from the beam rotator 810 and/or the spinner 830. Further, wireless power transmission may provide power to the beam rotator 810 and/or the spinner 830. It is to be appreciated that wireless control and wireless power may be implemented in any component in the LIDAR system consistent with disclosed embodiments.

As noted, the rotation of rotatable deflector 840 may occur about the tilt axis 872 according to predetermined vertical tilt increments. In some cases, as represented by FIG. 8C, the predetermined vertical tilt increments may be sized such that a first set of horizontal scan lines 876 (e.g., resulting from deflection of multibeam array 700 toward FOV 120) resulting from rotation of the rotatable deflector at a first tilt increment do not interleave with a second set of horizontal scan lines 878 resulting from rotation of the rotational deflector at a second tilt increment. In other words, the vertical tilt increments may be sized such that at each tilt increment of deflector 840 about tilt axis 872, the resulting sets of scan lines produced by horizontal scanning of projected multibeam array 850 (via rotation of deflector 840 about axis A) do not overlap, as shown in FIG. 8C. And in some cases, the tilt increments may be selected such that an inter-set line spacing 882 between one set of scan lines (e.g., spacing 882, as shown in FIG. 8C, between sets 876 and 878) may be substantially the same as the spacing 884 between adjacent horizontal scan lines in each set.

In another example, as shown in FIG. 8D, the predetermined vertical tilt increments of deflector 840 may be sized such that a first set of horizontal scan lines 876 resulting from rotation of rotatable deflector 840 at a first tilt increment at least partially interleave with a second set of horizontal scan lines 878 resulting from rotation of rotatable deflector 840 at a second tilt increment. Further still, a third set of scan lines 880 may at least partially interleave the first and/or second set of scan lines. By controlling the size of the vertical tilt increment of rotatable deflector about tilt axis 872, the spacing of interleaved sets of scan lines may be selectively controlled. In turn, because the proximity of scan lines is related to a potential scan resolution, decreasing spacing between interleaved scan lines can enable selectable control of point cloud resolution produced by LIDAR system 80.

In the example represented by FIG. 8D, the tilt increment of rotatable deflector 840 about tilt axis 872 has been modified such that three sets of scan lines (876, 878, and 880) partially overlap. In this particular example, a tilt increment has been selected such that one from each of sets 878 and 880 are interleaved between adjacent scan lines from set 876. While many combinations of tilt increments can result in the behavior represented by FIGS. 8C and 8D, in one example, if it is assumed that the angular spacing between scan lines in each set 876, 878, and 880 is 1 degree, then the tilt increment may be set to 4 degrees such that each new set of scan lines will be non-interleaving with the previous, and the first line of the new set will also be offset from the last line of the previous set by 1 degree, as shown in FIG. 8C. In the example of FIG. 8D, the tilt increment of rotatable deflector about tilt axis 872 has been selected such that scan line sets 876, 878, and 880 are at least partially interleaved. In this case, the tilt increment has been selected to be about 0.33 degrees such that the first scan line of both of sets 878 and 880 are positioned between the first and second scan lines of set 876 (at about ⅓ and ⅔ of the distance between lines 1 and 2 of set 876, respectively). In this way, the density of scan lines used to scan FOV 120 can be increased, which can result in higher point cloud resolutions (assuming there are no offsetting changes in the rotational rate of deflector 840 about axis A or with the pulse rate associated with laser source 802).

Various control schemes may be employed to provide the variable resolution capability offered by controlling the tilt increment of deflector 840 about axis 872. For example, in some cases, only a particular region of interest (ROI) associated with FOV 120 (e.g., in a region overlapping with a horizon) may be scanned using interleaved scan lines, and other areas of the FOV may be scanned using non-interleaving scan lines. In the example of FIGS. 8C and 8D, an initial tilt increment of 4 degrees may be chosen for deflector 840, such that the initial scans proceed as shown in FIG. 8C where sets of scan lines are not interleaved. Approaching an ROI, however, the tilt increment may be decreased (e.g., to 0.33 degrees, 0.5 degrees, 1.5 degrees, 2.5 degrees, etc.) such that sets of scan lines at least partially overlap—one particular example being shown in FIG. 8D. After scanning the ROI, the tilt increment may be returned to its original value (e.g., 4 degrees) or to another value that results in less interleaving between sets of scan lines or even wider angular spacing between sequential sets of scan lines.

Returning to FIG. 8A, scanning system 82 may scan a horizontal FOV of 360 degrees, with a vertical scan of +/−15 degrees, or other suitable vertical scan range. For automotive applications, spinner 830 may rotate deflector 840 about scan axis A for horizontal scanning, and as described above, deflector 840 may be rotated about a horizontal axis (e.g., tilt axis 872) to provide vertical scanning relative to FOV 120. Of course, other configurations may also be employed. For example, the deflection direction may not be vertical, and the spinner 830 may not be placed horizontally. Each of the spinner 830 and deflector 840, or both, may be tilted with respect to the optical axis A of the LIDAR system 80. For example, the deflector 840 may have a span of rotation about a reference position defined by +/−10, 15, 20, 25, 30 degrees, with a full rotation span of 20, 30, 40, 50, or 60 degrees. The deflector 840 in its reference position may be positioned at an angle relative to the scan axis A (this may also be described as a tilt with respect to the spinner plane of rotation). Alternatively, scan axis A may be tilted at an angle off of the vertical position. In either case, rotation of deflector 840 may generate a rotating beam pattern that follows a scan plane tilted relative to a horizontal plane. In the example of FIGS. 8A and 8B, the scan axis (spinning axis) A and the tilt axis 872 are perpendicular to one another, but this is not necessarily so. In some cases, an angle between scan axis A and tilt axis 872 may be less than or greater than 90 degrees.

Various components may be used to actuate rotatable deflector 840. For example, mirror 842 of FIG. 8A may be tilted (e.g., about tilt axis 872) using one or more actuators. The actuator may, for example, be a mechanical actuator, a MEMS actuator, rotary actuator, wireless actuator or other mechanisms to tilt the mirror 842 about tilt axis 872. Spinner 830 may comprise a motor for providing a spinning motion around the scan axis A.

As shown in FIG. 8A, scanning system 82 also includes a beam rotator 810. Beam rotator 810 may be placed in any suitable location along an optical path associated with system 80. In the example shown, beam rotator 810 is located between spinner 830 and the TX/RX optics 800. Beam rotator 810 may be configured to cause rotation of the beam pattern of the plurality of laser beams (or the one or more circularly shaped, elongated or elliptical cross section beams) generated by laser source 802 relative to the scanning axis A of rotatable deflector 840. Particularly, beam rotator 810 may rotate the beam pattern associated with the one or more laser beams of source 802 such that the beam pattern maintains a constant or substantially constant orientation relative to deflector 840 as deflector 840 rotates about scan axis A. In this way, a significant scanning challenge, as described above relative to FIGS. 7A-7D can be addressed.

In some embodiments, and as represented by FIGS. 8E-8H, beam rotator 810 and deflector 840 may rotate in a coordinated manner such that beam array 700 may be maintained in a substantially fixed orientation with respect to deflector 840 as deflector 840 rotates about scan axis A. In other words, beam rotator 810 may cause rotation of multibeam array 700 about scan axis A in coordination with the rotation of rotatable deflector 840 about scan axis A.

FIGS. 8E-8H provide diagrammatic representations of the relative orientations of deflector 840 and multibeam array 700 at several angular orientations of deflector 840 (i.e., at 0 degrees (FIG. 8E), 90 degrees (FIG. 8F), 180 degrees (FIG. 8G), and 270 degrees (FIG. 8H)). As shown, as rotatable deflector rotates about scan axis A, beam rotator 810 causes a corresponding rotation of multibeam array 700, and, therefore, of the beam pattern associated with multibeam array 700. Thus, after deflector 840 has rotated through 90 degrees, as shown in FIG. 8F, beam rotator 810 has caused a corresponding rotation of multibeam array 700 also by 90 degrees. As a result, the relative orientation of multibeam array 700 and the corresponding beam pattern relative to the incident face of deflector 840 remains constant as deflector 840 rotates. Similarly, as deflector 840 continues to rotate to its 180 degree angular position (FIG. 8G) and to its 270 degree angular position (FIG. 8H) beam rotator 810 continues to cause a corresponding rotation of multibeam array 700 such that the relative orientation of multibeam array 700 and its associated beam pattern relative to the incident face of deflector 840 continues to remain constant as deflector 840 rotates. As shown in FIGS. 8E-8H, beam rotator 810 may be configured to rotate the beam pattern associated with multibeam array 700 in a direction about scan axis A that is the same as a direction of rotation of rotatable deflector 840 about scan axis A.

Various structures may be used to provide beam rotator 810. For example, in some cases, beam rotator 810 may include a Dove prism, a Pechan prism, K mirrors, or other image rotating optical elements. It is to be appreciated that the beam rotator may also include one or more optical elements to achieve the desired beam pattern (e.g., lenses, collimators, etc.).

The frequency of rotation of beam rotator 810 may be selected based on the frequency of rotation of rotatable deflector 840 and based on geometric characteristics of LIDAR system 80, properties/characteristics of beam rotator 810, etc. As noted above, the rotation of rotatable deflector 840 about scan axis A and the rotation of the beam pattern of multibeam array 700 about scan axis A may combine to maintain the beam pattern of the plurality of laser beams of multibeam array 700 in a substantially fixed orientation relative to a deflection surface of rotatable deflector 840 as deflector 840 rotates about scan axis A. To maintain this fixed or substantially fixed relative orientation, a frequency of rotation of the beam pattern provided by beam rotator 810 may match or substantially match a rotation frequency of rotatable deflector 840 about scan axis A (as represented in FIGS. 8E-8H). A matched rotation rate between the beam pattern of multibeam array 700 and deflector 840 may be achieved, in some cases, by employing a frequency of rotation associated with beam rotator 810 that matches or substantially matches a frequency of rotation of rotatable deflector 840. In other embodiments, a frequency of rotation associated with beam rotator 810 may be substantially one half a frequency of rotation of rotatable deflector 840. For example, in the case of a Dove prism, as the Dove prism rotates the input image is inverted as it rotates, which results in an effective doubling of the rotational frequency of the beam rotator 810. That is, a physical rotation of a Dove prism at a frequency of X will result in rotation of multibeam array 700 and its corresponding beam pattern by a frequency of 2×. As a result, in embodiments that include a Dove prism, the frequency of rotation associated with beam rotator 810 may be substantially one half a frequency of rotation of rotatable deflector 840. It is to be appreciated that the frequency of rotation of the beam rotator 810 with respect to rotatable deflector 840 may be any ratio required by the LIDAR system 80.

In some embodiments, the beam rotator 810 and the rotatable deflector 840 may be rotated by a shared motor. Such an arrangement can facilitate matching of rotational frequencies of beam rotator 810 and deflector 840.

In addition to maintaining a fixed or substantially fixed rotational orientation between a beam pattern of multibeam array 700 and rotatable deflector 840, beam rotator 810 can also enable other capabilities. For example, because the rotation of beam rotator 810 may be selectively controlled both in frequency and phase, the rotational characteristics and or orientation of beam rotator 810 relative to deflector 840 may be selected during operation to correct for drift, selectively control scan line spacing (and therefore point cloud resolution), compensate for alignment disparities between system components, etc.

In some cases, even where a shared motor is used to rotate both the beam rotator 810 and deflector 840, drift can result in mismatches between the relative frequency or phase of rotation of deflector 840 and the beam pattern associated with multibeam array 700. In some embodiments, LIDAR system 80 may include circuitry to selectively shift a phase of rotation of the beam rotator 810 relative to a phase of rotation of the rotatable deflector 840 to correct for drift associated with a mismatch between a frequency of rotation of the beam pattern provided by the beam rotator 810 and a rotation frequency of the rotatable deflector 840. Such circuitry may include any suitable circuit elements to delay or advance a phase of beam rotator 810 (e.g., one or more inverters, transistors, op amps, etc.). In other cases, the circuitry may include at least one processor configured to monitor a relative phase between the deflector 840 and the beam pattern associated with multibeam array 700. In either case, the selective phase shift of beam rotator 810 relative to deflector 840 may be implemented based on feedback indicating the presence of the mismatch between the frequency and/or phase of rotation of the beam pattern provided by the beam rotator 810 and the rotation frequency of the rotatable deflector 840. It is to be appreciated that the selective phase shift imparted to beam rotator 810 may include a positive or a negative relative phase shift.

In some embodiments, the LIDAR system 80 may further include circuitry to selectively shift a phase of rotation of the beam rotator 810 relative to a phase of rotation of the rotatable deflector 840 to compensate for an alignment disparity between system components (e.g., between the light source 802 and the rotatable deflector 840). In many optical systems, there may be a need to achieve precise alignment between system components to provide desired operational characteristics. Such requirements for alignment precision can significantly impact manufacturing costs and can render systems susceptible to environmental effects, such as vibration or temperature variations, during operation. In the presently disclosed systems, because the beam rotator 810 can be selectively rotated, beam rotator 810 can be used to offset alignment disparities between certain optical components. In addition, angular rotation adjustments may be made to the rotation of the beam rotator 810 that may allow additional tolerance in the mounting position and orientation of the optical components (e.g. light source and detection unit) due to the ability to compensate for the larger tolerance in position thus aiding the manufacturing process. For example, if during manufacture or during operation, a relative alignment between light source 802 and deflector 840 results in a beam pattern incident upon deflector 840 that is not oriented as intended, a phase of beam rotator 810 may be advanced or delayed until the desired relative orientation is achieved. Such a correction may be performed during manufacture, or as described above, during operation to compensate for alignment drift or other effects.

The relative phase between beam rotator 810 and deflector 840 may also be selectively controlled to adjust the scan resolution offered by the disclosed LIDAR systems. Specifically, a relative phase between rotation of the beam pattern provided by beam rotator 810 and rotation of rotatable deflector 840 may be selectively advanced or delayed to control spacing between the plurality of laser beams deflected from rotatable deflector 840. As a result, the spacing between scan lines used to scan FOV 120 can be controlled by advancing or delaying this relative phase. FIGS. 8I-8K provide a graphical illustration of this concept. For example, as shown in FIG. 8I, the relative orientation of beam pattern 888 is selected such that beam pattern 888 is aligned parallel to an axis Z (e.g., a vertical axis) associated with rotatable deflector 840. In this relative orientation between beam pattern 888 and deflector 840, the resulting scan lines projected to FOV 120 will have a maximum spacing 894.

FIG. 8J represents an example in which the phase of beam rotator 810 has been delayed with respect to deflector 840 such that the relative orientation of beam pattern 888 is rotated in a negative direction with respect to axis Z. Similarly, FIG. 8K represents an example in which the phase of beam rotator 810 has been advanced with respect to deflector 840 such that the relative orientation of beam pattern 888 is rotated in a positive direction with respect to axis Z. In both of the examples of FIGS. 8J and 8K, the resulting scan lines projected toward FOV 120 will have a spacing less than maximum spacing 894. For example, in the delayed phase example of FIG. 8J, the scan lines will have a spacing 896 that is less than spacing 894. The spacing between scan lines can be selected by controlling the degree of rotation of beam pattern 888 relative to deflector 840. For example, in the advanced phase example of FIG. 8K, beam pattern 888 has been rotated relative to axis Z by a rotational angle whose absolute value is greater than the degree of rotation of beam 888 relative to axis Z, as exhibited in the FIG. 8J example. As a result, scan line spacing 898 in the FIG. 8K example will be less than scan line spacing 896 in the FIG. 8J example.

By advancing or delaying the relative phase of beam rotator 810 with respect to deflector 840, the spacing between scan lines projected toward FOV 120 may be controlled. For example, by advancing or delaying this relative phase by up to +/−90 degrees, any desired scan line spacing between maximum spacing 894 and zero spacing (e.g., at +/−90 degrees or even approaching +/−90 degrees depending on beam spot sizes) where scan lines will at least partially overlap.

Notably, a desired beam pattern 888 orientation relative to deflector 840 may be maintained over any portion of a scan of LIDAR FOV 120. That is, a selected relative orientation may be maintained over an entire FOV scan such that the scan lines used to scan the FOV have substantially constant spacing (e.g., 894, 896, 898, etc.) relative to one another. In other cases, however, the relative orientation between beam rotator 810 and deflector 840 may be selectively advanced or delayed to change the scan line spacing during a single scan of the FOV. For example, as scanning of the FOV approaches a horizon or another ROI, the phase of beam rotator 810 relative to deflector 840 may be delayed or advanced in order to decrease the spacing between scan lines and, therefore, potentially increase point cloud resolution in these areas of interest.

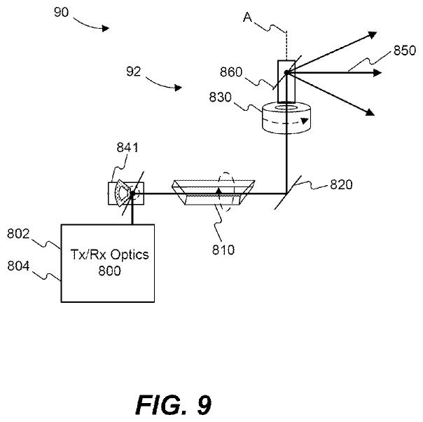

In some cases, as noted above, deflector 840 may rotate about scan axis A, but may not have the capability to rotate about another axis, such as tilt axis 872. In such cases, changes in vertical position of the scan lines projected toward FOV 120 may be achieved using other components. FIG. 9 depicts a LIDAR system 90 having a deflector 860 configured to rotate only about scan axis A. Rotation of deflector 860 about scan axis A will result in beams 850 being directed toward FOV 120 along scan lines (e.g., horizontally oriented scan lines) as deflector 860 rotates. To shift the position of beams 850 to different sets of scan lines, the embodiment of FIG. 9 includes a primary deflector 841 configured to vary angles of incidence of the plurality of laser beams generated by light source 802 relative to rotatable deflector 860. Variations in the angles of incidence of the generated light beams upon deflector 860 may have the effect of causing a shift (e.g., a vertical shift) in location of sets of scan lines associated with beams 850. Primary deflector 841 may be placed at any suitable location along the optical path of LIDAR system 90. In some cases, as shown in FIG. 9, primary deflector 841 may be positioned downstream to the TX/RX optics 800, but upstream of beam rotator 810. In this case, the primary scan deflector 841 may be configured to vary angles of incidence of the plurality of laser beams generated by light source 802 relative to the beam rotator 810 and, therefore, also relative to rotatable deflector 860. In other embodiments, primary deflector 841 may be placed along an optical path between beam rotator 810 and spinner 830. One advantage of the configuration shown in FIG. 9 is that the primary deflector 841 is not physically rotated by the spinner 830, and rotatable deflector 860 may include a relatively lightweight fixed mirror. As a result, the rotational inertia of the spinning components may be reduced relative to other embodiments (e.g., the embodiment of FIG. 8A).

Returning to FIG. 1A, some embodiments of the disclosed LIDAR systems may include a window 124 through which the laser beams (e.g., a plurality of laser beams, one or more elongated spot laser beams, etc.) may be projected toward FOV 120. In some cases, window 124 may have a curved profile, such as a part cylinder. As a result, certain optical aberrations may be imparted upon the beams projected toward the FOV or upon reflected beams returning from the FOV. To offset or correct for such aberrations, one or more optical components may be introduced to the disclosed LIDAR systems. For example, in some cases, at least one lens may be included to correct for one or more aberrations imparted to at least one of the plurality of laser beams by the curved window.

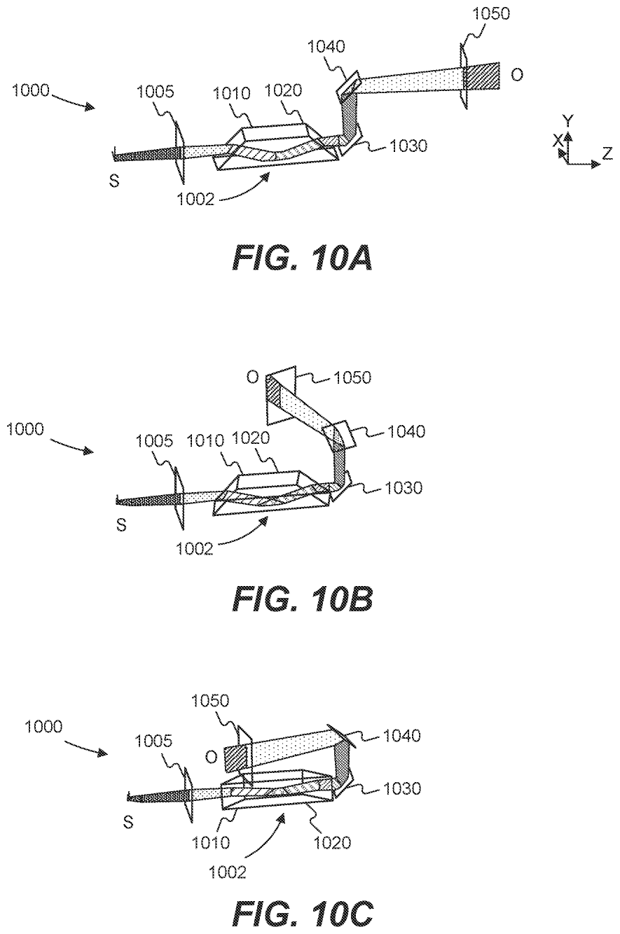

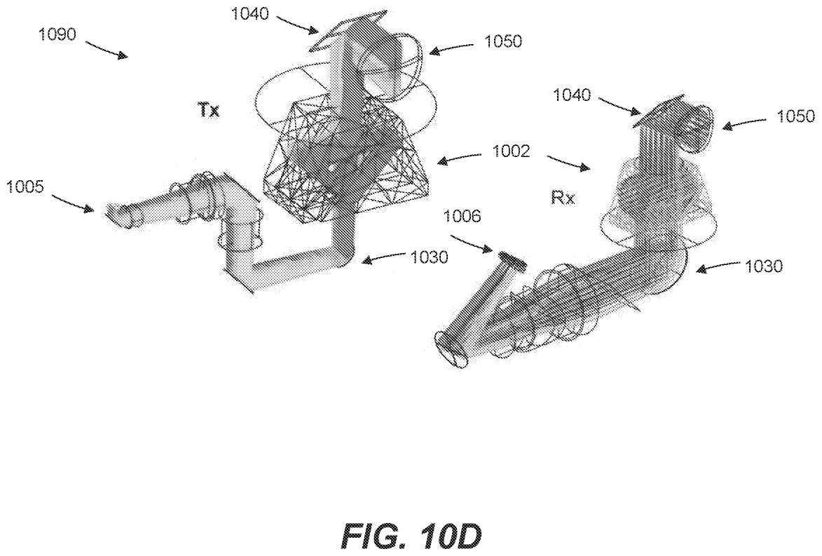

FIG. 10A-10C represent further examples of the combined effect of the spinner motion and beam rotator motion on the orientation of the beam pattern of the multibeam array on the rotatable deflector. For ease of explanation, the optical path portion 1005 is shown out-of-perspective, and its different optical elements are diagrammatically represented. Further, Dove prism 1002 with its faces 1010 and 1020 (element 810 in FIG. 8A) is shown in a geometrical representation. The optical path 1000 may be a transmit and receive path, and, for ease of explanation, it will be described herein as the transmit direction. Element 1005 represents the exit of the light source (element 802 in FIG. 8A) or additional optical elements (not shown in FIG. 8A). Element 1030 represents the fixed folding mirror 820 of FIG. 8A. Element 1040 (e.g., rotatable deflector 840) spins around the scan axis A. Element 1050 represents the exit toward the FOV (e.g., window 124). In operation, element 1040 (deflector 840) spins about the scan axis A, and the Dove prism 1002 (beam rotator 810) is rotated in coordination with element 1040. This is illustrated in FIGS. 10A-10C in the different rotation positions of elements 1002 and 1040 during a spin cycle of element 1040. The beams S are generated by the beam generator (element 802 in FIG. 8) and arranged as a multibeam array. The beam pattern of the multibeam array is inverted and rotated by the Dove prism 1002 in coordination with element 1040. Specifically, the beam pattern is maintained in a fixed or substantially fixed orientation relative to element 1040 through rotation of beam rotator 810/Dove prism 1002.

FIG. 10D shows an illustrative embodiment of the optics layout of an exemplary LIDAR system consistent with disclosed embodiments. Element 1090 shows the transmit and receive optical paths of the LIDAR system. Element 1005 represents the exit of the light source (e.g. laser or additional optical elements) in the transmit optical path. Element 1006 represents the at least one sensor in the receive optical path that may include a plurality of detectors constructed from a plurality of detecting elements. Element 1030 represents a fixed folding mirror which may be present in both the transmit and receive optical paths. In the embodiment shown in FIG. 10D, the beam rotator 810 may be implemented with a rotatable Pechan prism 1002 shown in the embodiment positioned between the folding mirror and the rotatable detector 1040. Element 1050 represents the exit toward the FOV wherein the beam pattern is maintained in a fixed or substantially fixed orientation relative to element 1040 through rotation of Pechan prism 1002.

Beam rotator 810 may have various configurations to provide a desired set of optical properties. For example, beam rotator 810, e.g., a Dove prism, may be made from optical glass for transmitting wavelengths between 500 nm to 2700 nm. The Dove prism may be coated with an anti-reflective (AR) material to minimize reflections from the prism surface. For example, a coating with reflectance below 1% may be used. In an alternate embodiment, the beam rotator 810 may include a Pechan prism. A Pechan prism provides similar optical properties as a Dove prism, but in some cases may have a smaller size and lighter weight and/or may facilitate a reduction in the optical path length of the beam rotator 810.

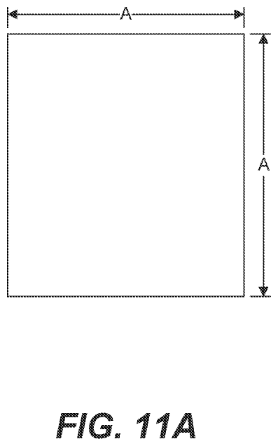

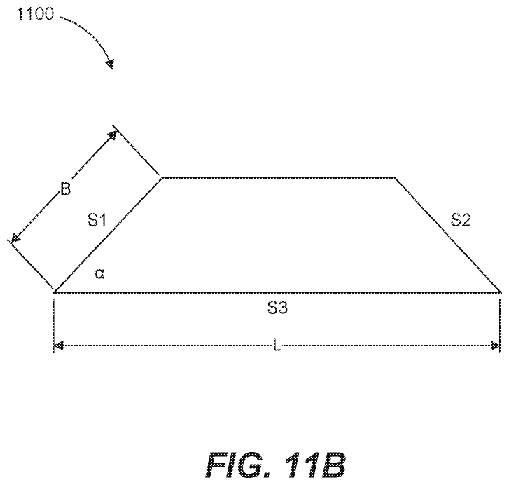

A Dove prism included in disclosed embodiments may have any suitable dimensions. For example, in cross section, as shown in FIG. 11A, a Dove prism may have dimensions, A, in a range of about 5 mm to 30 mm. A length B of the Dove prism's surface of the longitudinal cross-section, as shown in FIG. 11B, may be in the range of but not limited to 7 mm to 45 mm. The length L of the Dove prism's surface of the longitudinal cross-section may be in the range of but not limited to 20 mm to 140 mm. In one example, the base angle α may be 45 degrees but it is to be appreciated that the base angle may be any angle required by the application.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A LIDAR system, comprising:
a light source configured to generate a plurality of laser beams arranged in a beam pattern;
a rotatable deflector configured to rotate about a scanning axis and to deflect the plurality of laser beams toward a field of view of the LIDAR system;
a beam rotator configured to cause rotation of the beam pattern of the plurality of laser beams relative to the scanning axis of the rotatable deflector; and
at least one sensor configured to receive, via the rotatable deflector and the beam rotator, laser light resulting from one or more of the plurality of laser beams reflected from at least one object in the field of view of the LIDAR system.

2. The LIDAR system of claim 1, wherein the scanning axis of the rotatable deflector is oriented substantially vertically.

3. The LIDAR system of claim 1, wherein the rotatable deflector includes a folding mirror.

4. The LIDAR system of claim 3, wherein the rotatable deflector is further configured to rotate about a vertical scan axis.

5. The LIDAR system of claim 4, wherein the rotation about the vertical scan axis occurs according to predetermined vertical tilt increments.

6. The LIDAR system of claim 5, wherein the predetermined vertical tilt increments are sized such that a first set of horizontal scan lines resulting from rotation of the rotatable deflector at a first tilt increment do not interleave with a second set of horizontal scan lines resulting from rotation of the rotational deflector at a second tilt increment.

7. The LIDAR system of claim 5, wherein the predetermined vertical tilt increments are sized such that a first set of horizontal scan lines resulting from rotation of the rotatable deflector at a first tilt increment at least partially interleave with a second set of horizontal scan lines resulting from rotation of the rotational deflector at a second tilt increment.

8. The LIDAR system of claim 4, wherein the vertical scan axis is oriented substantially horizontally relative to the field of view of the LIDAR system.

9. The LIDAR system of claim 1, wherein the beam rotator is configured to rotate the beam pattern in a direction about the scanning axis of the rotatable deflector that is the same as a direction of rotation of the rotatable deflector about the scanning axis.

10. The LIDAR system of claim 1, wherein the rotation of the rotatable deflector about the scanning axis and the rotation of the beam pattern about the scanning axis combine to maintain the beam pattern of the plurality of laser beams in a substantially fixed orientation relative to a deflection surface of the rotatable deflector as it rotates about the scanning axis.

11. The LIDAR system of claim 1, wherein the beam rotator includes a Pechan prism.

12. The LIDAR system of claim 1, wherein the beam rotator includes a Dove prism.

13. The LIDAR system of claim 1, wherein the beam rotator includes at least a pair of K mirrors.

14. The LIDAR system of claim 1, wherein a frequency of rotation of the beam pattern provided by the beam rotator substantially matches a rotation frequency of the rotatable deflector.

15. The LIDAR system of claim 1, wherein a frequency of rotation associated with the beam rotator substantially matches a frequency of rotation of the rotatable deflector.

16. The LIDAR system of claim 1, wherein a frequency of rotation associated with the beam rotator is substantially one half a frequency of rotation of the rotatable deflector.

17. The LIDAR system of claim 1, wherein the beam rotator and the rotatable deflector are rotated by a shared motor.

18. The LIDAR system of claim 1, wherein the LIDAR system further includes circuitry to selectively shift a phase of rotation of the beam rotator relative to a phase of rotation of the rotatable deflector to correct for drift associated with a mismatch between a frequency of rotation of the beam pattern provided by the beam rotator and a rotation frequency of the rotatable deflector.

19. The LIDAR system of claim 18, wherein the circuitry includes at least one processor.

20. The LIDAR system of claim 18, wherein the selective phase shift is implemented based on feedback indicating the presence of the mismatch between the frequency of rotation of the beam pattern provided by the beam rotator and the rotation frequency of the rotatable deflector.

21. The LIDAR system of claim 20, wherein the selective phase shift is a positive or a negative relative phase shift.

22. The LIDAR system of claim 1, wherein the LIDAR system further includes circuitry to selectively shift a phase of rotation of the beam rotator relative to a phase of rotation of the rotatable deflector to compensate for an alignment disparity between the light source and the rotatable deflector.

23. The LIDAR system of claim 1, wherein the light source includes an array of M×N lasers where N>1 and M does not equal N.

24. The LIDAR system of claim 1, further including a primary scan deflector located in an optical path between the beam rotator and the rotatable deflector, wherein the primary scan deflector is configured to vary angles of incidence of the plurality of laser beams relative to the rotatable deflector.

25. The LIDAR system of claim 24, wherein the varied angles of incidence enable vertical shifting of horizontal scan lines associated with scanning of the plurality of laser beams relative to the field of view of the LIDAR system.

26. The LIDAR system of claim 1, further including a primary scan deflector located in an optical path between the light source and the beam rotator, wherein the primary scan deflector is configured to vary angles of incidence of the plurality of laser beams relative to the rotatable deflector.

27. The LIDAR system of claim 26, wherein the varied angles of incidence enable vertical shifting of horizontal scan lines associated with scanning of the plurality of laser beams relative to the field of view of the LIDAR system.

28. The LIDAR system of claim 1, wherein a relative phase between rotation of the beam pattern provided by the beam rotator and rotation of the rotatable deflector is selectively advanced or delayed to control spacing between the plurality of laser beams deflected from the rotatable deflector.

29. The LIDAR system of claim 1, wherein the LIDAR system further includes a curved window through which the plurality of laser beams deflected from the rotatable deflector pass.

30. The LIDAR system of claim 29, further including at least one lens to correct for one or more aberrations imparted to at least one of the plurality of laser beams by the curved window.

31. A LIDAR system, comprising:
a light source configured to generate at least one laser beam having an elongated cross section;
a rotatable deflector configured to rotate about a scanning axis and to deflect the at least one laser beam toward a field of view of the LIDAR system;
a beam rotator configured to cause rotation of the elongated cross section of the at least one laser beam relative to the scanning axis of the rotatable deflector; and
at least one sensor configured to receive, via the rotatable deflector and the beam rotator, laser light resulting from the at least one laser beam reflected from at least one object in the field of view of the LIDAR system.
